(19) United States
(12) Patent Application Publication
(10) Pub. No.: US 2013/0065682 A1
(43) Pub. Date: Mar. 14, 2013

(54) GAME SYSTEM, PORTABLE GAME DEVICE, METHOD OF CONTROLLING INFORMATION PROCESSING UNIT, AND NON-TRANSITORY STORAGE MEDIUM ENCODED WITH COMPUTER READABLE PROGRAM FOR CONTROLLING INFORMATION PROCESSING UNIT, CAPABLE OF CHANGING GAME PROCESSING IN CONSIDERATION OF POSITION OF OPERATION APPARATUS TO BE OPERATED

(71) Applicants: Toshiharu Izuno, Kyoto-shi (JP); Yuya Satoh, Kyoto-shi (JP); Hiroyuki Takahashi, Shinjuku-ku (JP); Shugo Takahashi, Shinjuku-shi (JP)

(72) Inventors: Toshiharu Izuno, Kyoto-shi (JP); Yuya Satoh, Kyoto-shi (JP); Hiroyuki Takahashi, Shinjuku-ku (JP); Shugo Takahashi, Shinjuku-shi (JP)

(73) Assignee: NINTENDO CO., LTD., Kyoto (JP)

(21) Appl. No.: 13/315,433

(22) Filed: Dec. 9, 2011

(30) Foreign Application Priority Data
Sep. 9, 2011 (JP) 2011-197032

(51) Int. Cl. A63F 13/00; A63F 9/24

(52) U.S. Cl. 463/31; 463/43

(57) ABSTRACT

An exemplary embodiment provides a game system. The game system includes an operation apparatus and an information processing unit. The information processing unit includes a viewpoint mode switching unit for setting a first viewpoint mode for displaying on the display portion a display image picked up based on a position and a direction of image pick-up of a first virtual camera in a virtual space on a game when position data of the operation apparatus obtained by the sensor portion is in a first range and setting a second viewpoint mode for displaying on the display portion a display image picked up based on a position and a direction of image pick-up of a second virtual camera when the position data is in a second range, and a game processing unit for performing game processing in accordance with the operation input accepted by the operation portion.

This nonprovisional application is based on Japanese Patent Application No. 2011-197032 filed with the Japan Patent Office on Sep. 9, 2011, the entire contents of which are hereby incorporated by reference.

### FIELD

The invention generally relates to a game system, a portable game device, a method of controlling an information processing unit, and a non-transitory storage medium encoded with a computer readable program for controlling an information processing unit.

### BACKGROUND AND SUMMARY

Some conventional portable game devices are provided with an angular velocity sensor representing one type of an inertial sensor. For example, an angle of rotation at the time when a user moves the game device is sensed by the angular velocity sensor. Then, an image resulting from image pick-up of a virtual object in a virtual space with a virtual camera in the virtual space moved in accordance with the sensed angle of rotation is generated. Thus, a virtual object viewed from different viewpoints as a position of the virtual camera is moved by moving the portable game device can be displayed.

Meanwhile, in a case of the portable game device, various operation positions for operating the game device can be taken, and there are also for example a case where a game device is placed and operated on a flat surface such as a desk and for example a case where a game device is set with hands at an angle close to perpendicular.

In a conventional game device, though game processing utilizing motion of the device has been performed, change in game processing in consideration of an operation position of the operated device has not been made.

An exemplary embodiment provides a game system, a portable game device, a method of controlling an information processing unit, and a non-transitory storage medium encoded with a computer readable program for controlling an information processing unit, capable of changing game processing in consideration of an operation position of an operated device.

An exemplary embodiment provides a game system. The game system includes an operation apparatus and an information processing unit for transmitting and receiving data to and from the operation apparatus. The operation apparatus includes a display portion for displaying information, an operation portion for accepting a user's operation input, and a sensor portion for obtaining position data in a space where the operation apparatus is present. The information processing unit includes a viewpoint mode switching unit for setting a first viewpoint mode for displaying on the display portion a display image picked up based on a position and a direction of image pick-up of a first virtual camera in a virtual space on a game when the position data of the operation apparatus obtained by the sensor portion is in a first range and setting a second viewpoint mode for displaying on the display portion a display image picked up based on a position and a direction of image pick-up of a second virtual camera when the position data of the operation apparatus is in a second range, and a game processing unit for performing game processing in accordance with the operation input accepted by the operation portion.

According to the exemplary embodiment, the viewpoint mode switching unit for setting a first viewpoint mode for displaying on the display portion a display image picked up based on a position and a direction of image pick-up of a first virtual camera in a virtual space on a game when position data of an axis of a prescribed direction in a reference direction in the space where the operation apparatus is present is in a first range and setting a second viewpoint mode for displaying on the display portion a display image picked up based on a position and a direction of image pick-up of a second virtual camera when position data of the operation apparatus is in a second range is provided, so that change in game processing in accordance with the viewpoint mode in accordance with the operation position can be made and resultant game processing can be performed. Therefore, zest of a game can be increased. In addition, since switching between the viewpoint modes can be made in accordance with the operation position, an operation of a button or the like for switching between the viewpoint modes is not necessary, a desired viewpoint mode can readily be set, and operability is also good.

In an exemplary embodiment, the operation portion has a direction input portion for accepting at least an input of a direction, and the game processing unit moves a first object provided in the virtual space in accordance with the input of the direction accepted by the direction input portion.

In an exemplary embodiment, the game processing unit controls the position and the direction of image pick-up of the second virtual camera in accordance with the position data of the operation apparatus in the second viewpoint mode.

According to the exemplary embodiment, in the second viewpoint mode, the position and the direction of image pick-up of the second virtual camera are controlled in accordance with the position data of the operation apparatus. Thus, a viewpoint is further changed in accordance with the operation position and hence zest of a game is further increased.

In an exemplary embodiment, the game processing unit provides a second object of which movement in the virtual space is controlled, and the game processing unit controls movement of the second object in accordance with the operation input accepted by the operation portion at prescribed timing in the first viewpoint mode and controls movement thereof in accordance with the position data of the operation apparatus at prescribed timing in the second viewpoint mode.

In an exemplary embodiment, the game processing unit provides a second object of which movement in the virtual space is controlled, and the game processing unit controls movement of the second object in accordance with the operation input accepted by the operation portion at prescribed timing in the first viewpoint mode, and controls movement thereof in accordance with the operation input accepted by the operation portion at prescribed timing and controls movement thereof in accordance with the position data of the operation apparatus at timing different from the prescribed timing in the second viewpoint mode.

According to the exemplary embodiment, in the second viewpoint mode, movement of the second object is controlled in accordance with the position data of the operation apparatus. Therefore, game processing in coordination with a manner of operation (motion) of the operation apparatus can be performed and hence zest of a game is further increased.

In an exemplary embodiment, in the virtual space, the first virtual camera is set at a position higher than positions of the first object and the second virtual camera.

According to the exemplary embodiment, by setting the first virtual camera at a position higher than the position of the second virtual camera, an overhead view image can be obtained and displayed so that zest of a game is increased owing to different viewpoints.

In an exemplary embodiment, a case where the position data of the operation apparatus is in the first range refers to a case where an orientation of a display surface of the display portion is close to horizontal, and a case where it is in the second range refers to a case where an orientation of the display surface of the display portion is close to vertical.

According to the exemplary embodiment, since the viewpoint mode can be switched between a case where an orientation of the display surface of the display portion is close to horizontal and a case where an orientation of the display surface of the display portion is close to vertical, a desired viewpoint mode can readily be set and operability is good.

In an exemplary embodiment, the sensor portion corresponds to an inertial sensor.

In an exemplary embodiment, the inertial sensor includes an acceleration sensor and an angular velocity sensor.

According to the exemplary embodiment, since the sensor portion is implemented by an acceleration sensor and an angular velocity sensor, the operation position and the manner of operation (motion) of the operation apparatus can both be detected and independently be reflected on game processing. Therefore, zest of a game is increased.

In an exemplary embodiment, the information processing unit is provided in a main body apparatus provided separately from the operation apparatus, the operation apparatus further includes a communication portion for transmitting and receiving data to and from the main body apparatus, the communication portion of the operation apparatus transmits the operation input accepted by the operation portion and the position data obtained by the sensor portion to the main body apparatus and receives game image data in accordance with the game processing performed by the information processing unit of the main body apparatus, and the display portion of the operation apparatus displays a game image in accordance with the received game image data.

According to the exemplary embodiment, since a portable game device or the operation apparatus is provided separately from the main body apparatus, operability is good.

An exemplary embodiment provides a game system. The game system includes an operation apparatus and an information processing unit for transmitting and receiving data to and from the operation apparatus. The operation apparatus includes a display portion for displaying information, an operation portion for accepting a user's operation input, and a sensor portion for obtaining first position data of an axis of a first prescribed direction in a reference direction in a space where the operation apparatus is present and second position data around an axis of a second prescribed direction. The information processing unit performs game processing in accordance with the operation input accepted by the operation portion when the first position data of the operation apparatus obtained by the sensor portion is in a first range and performs game processing in accordance with the operation input accepted by the operation portion and the second position data of the operation apparatus obtained by the sensor portion when the first position data of the operation apparatus obtained by the sensor portion is in a second range.

According to the exemplary embodiment, when the first position data of the operation apparatus is in the first range, game processing in accordance with the operation input accepted by the operation portion is performed, and when the first position data of the operation apparatus is in the second range, game processing in accordance with the operation input accepted by the operation portion and the second position data of the operation apparatus obtained by the sensor portion is performed. Namely, since inputs accepted in performing game processing in accordance with the operation position of the operation apparatus are different, zest of a game is increased.

An exemplary embodiment provides a portable game device. The portable game device includes an operation apparatus and an information processing unit for transmitting and receiving data to and from the operation apparatus. The operation apparatus includes a display portion for displaying information, an operation portion for accepting a user's operation input, and a sensor portion for obtaining position data in a space where the operation apparatus is present. The information processing unit includes a viewpoint mode switching unit for setting a first viewpoint mode for displaying on the display portion a display image picked up based on a position and a direction of image pick-up of a first virtual camera in a virtual space on a game when the position data of the operation apparatus obtained by the sensor portion is in a first range and setting a second viewpoint mode for displaying on the display portion a display image picked up based on a position and a direction of image pick-up of a second virtual camera when the position data of the operation apparatus is in a second range, and a game processing unit for performing game processing in accordance with the operation input accepted by the operation portion.

An exemplary embodiment provides a method of controlling an information processing unit, and the method of controlling an information processing unit is a method of controlling an information processing unit operating in cooperation with an operation apparatus having a display portion for displaying information. The method of controlling an information processing unit includes the steps of accepting a user's operation input, obtaining position data in a space where the operation apparatus is present, setting a first viewpoint mode for displaying on the display portion a display image picked up based on a position and a direction of image pick-up of a first virtual camera in a virtual space on a game when the obtained position data of the operation apparatus is in a first range and a second viewpoint mode for displaying on the display portion a display image picked up based on a position and a direction of image pick-up of a second virtual camera when the position data of the operation apparatus is in a second range, and performing game processing in accordance with the accepted operation input.

According to the exemplary embodiment, owing to the step of setting a first viewpoint mode for displaying on the display portion a display image picked up based on a position and a direction of image pick-up of a first virtual camera in a virtual space on a game when position data of an axis of a prescribed direction in a reference direction in the space where the operation apparatus is present is in a first range and a second viewpoint mode for displaying on the display portion a display image picked up based on a position and a direction of image pick-up of a second virtual camera when position data of the operation apparatus is in a second range, change in game processing in accordance with the viewpoint mode in accordance with the operation position can be made and resultant game processing can be performed, and therefore zest of a game can be increased. In addition, since switching between the viewpoint modes can be made in accordance with the operation position, an operation of a button or the like for switching between the viewpoint modes is not necessary, a desired viewpoint mode can readily be set, and operability is also good.

In an exemplary embodiment, the step of accepting a user's operation input includes the step of accepting at least an input of a direction, and in the step of performing game processing, a first object provided in the virtual space is moved in accordance with the accepted input of the direction.

In an exemplary embodiment, in the step of performing game processing, in the second viewpoint mode, the position and the direction of image pick-up of the second virtual camera are controlled in accordance with the position data of the operation apparatus.

According to the exemplary embodiment, in the second viewpoint mode, the position and the direction of image pick-up of the second virtual camera are controlled in accordance with the position data of the operation apparatus. Thus, a viewpoint is further changed in accordance with the operation position and hence zest of a game is further increased.

In an exemplary embodiment, the step of performing game processing includes the steps of providing a second object of which movement in the virtual space is controlled, controlling movement of the second object in accordance with the operation input accepted at prescribed timing in the first viewpoint mode, and controlling movement of the second object in accordance with the position data of the operation apparatus at prescribed timing in the second viewpoint mode.

In an exemplary embodiment, the step of performing game processing includes the steps of providing a second object of which movement in the virtual space is controlled, controlling movement of the second object in accordance with the operation input accepted at prescribed timing in the first viewpoint mode, and controlling movement of the second object in accordance with the operation input accepted at prescribed timing and controlling movement thereof in accordance with the position data of the operation apparatus at timing different from the prescribed timing in the second viewpoint mode.

According to the exemplary embodiment, in the second viewpoint mode, movement of the second object is controlled in accordance with the position data of the operation apparatus. Therefore, game processing in coordination with a manner of operation (motion) of the operation apparatus can be performed and hence zest of a game is further increased.

In an exemplary embodiment, in the virtual space, the first virtual camera is set at a position higher than positions of the first object and the second virtual camera.

According to the exemplary embodiment, by setting the first virtual camera at a position higher than the position of the second virtual camera, an overhead view image can be obtained and displayed, so that zest of a game is increased owing to different viewpoints.

In an exemplary embodiment, a case where the position data of the operation apparatus is in the first range refers to a case where an orientation of a display surface of the display portion is close to horizontal, and a case where it is in the second range refers to a case where an orientation of the display surface of the display portion is close to vertical.

According to the exemplary embodiment, since the viewpoint mode can be switched between a case where an orientation of the display surface of the display portion is close to horizontal and a case where an orientation of the display surface of the display portion is close to vertical, a desired viewpoint mode can readily be set and operability is good.

An exemplary embodiment provides a method of controlling an information processing unit. The information processing unit operates in cooperation with an operation apparatus having a display portion for displaying information. The method of controlling an information processing unit includes the steps of accepting a user's operation input, obtaining first position data of an axis of a first prescribed direction in a reference direction in a space where the operation apparatus is present and second position data around an axis of a second prescribed direction, and performing game processing in accordance with the accepted operation input when the obtained first position data of the operation apparatus is in a first range and performing game processing in accordance with the accepted operation input and the obtained second position data of the operation apparatus when the obtained first position data of the operation apparatus is in a second range.

According to the exemplary embodiment, when the first position data of the operation apparatus is in the first range, game processing in accordance with the accepted operation input is performed, and when the first position data of the operation apparatus is in the second range, game processing in accordance with the accepted operation input and the obtained second position data of the operation apparatus is performed. Namely, since inputs accepted in performing game processing in accordance with the operation position of the operation apparatus are different, zest of a game is increased.

An exemplary embodiment provides a non-transitory storage medium encoded with a computer readable program for controlling an information processing unit and executable by a computer of the information processing unit. The information processing unit operates in cooperation with an operation apparatus having a display portion for displaying information. The program for controlling an information processing unit includes instructions for accepting a user's operation input, instructions for obtaining position data in a space where the operation apparatus is present, instructions for setting a first viewpoint mode for displaying on the display portion a display image picked up based on a position and a direction of image pick-up of a first virtual camera in a virtual space on a game when the obtained position data of the operation apparatus is in a first range and setting a second viewpoint mode for displaying on the display portion a display image picked up based on a position and a direction of image pick-up of a second virtual camera when the position data of the operation apparatus is in a second range, and instructions for performing game processing in accordance with the accepted operation input.

According to the exemplary embodiment, owing to the step of setting a first viewpoint mode for displaying on the display portion a display image picked up based on a position and a direction of image pick-up of a first virtual camera in a virtual space on a game when position data of an axis of a prescribed direction in a reference direction in the space where the operation apparatus is present is in a first range and a second viewpoint mode for displaying on the display portion a display image picked up based on a position and a direction of image pick-up of a second virtual camera when position data of the operation apparatus is in a second range, change in game processing in accordance with the viewpoint mode in accordance with the operation position can be made and resultant game processing can be performed, and therefore zest of a game can be increased. In addition, since switching between the viewpoint modes can be made in accordance with the operation position, an operation of a button or the like for switching between the viewpoint modes is not necessary, a desired viewpoint mode can readily be set, and operability is also good.

In an exemplary embodiment, the instructions for accepting a user's operation input include instructions for accepting at least an input of a direction, and the instructions for performing game processing cause a first object provided in the virtual space to move in accordance with the accepted input of the direction.

In an exemplary embodiment, the instructions for performing game processing control the position and the direction of image pick-up of the second virtual camera in accordance with the position data of the operation apparatus in the second viewpoint mode.

According to the exemplary embodiment, in the second viewpoint mode, the position and the direction of image pick-up of the second virtual camera are controlled in accordance with the position data of the operation apparatus. Thus, a viewpoint is further changed in accordance with the operation position and hence zest of a game is further increased.

In an exemplary embodiment, the instructions for performing game processing include instructions for providing a second object of which movement in the virtual space is controlled, instructions for controlling movement of the second object in accordance with the operation input accepted at prescribed timing in the first viewpoint mode, and instructions for controlling movement of the second object in accordance with the position data of the operation apparatus at prescribed timing in the second viewpoint mode.

In an exemplary embodiment, the instructions for performing game processing include instructions for providing a second object of which movement in the virtual space is controlled, instructions for controlling movement of the second object in accordance with the operation input accepted at prescribed timing in the first viewpoint mode, and instructions for controlling movement of the second object in accordance with the operation input accepted at prescribed timing and instructions for controlling movement thereof in accordance with the position data of the operation apparatus at timing different from the prescribed timing in the second viewpoint mode.

According to the exemplary embodiment, in the second viewpoint mode, movement of the second object is controlled in accordance with the position data of the operation apparatus. Therefore, game processing in coordination with a manner of operation (motion) of the operation apparatus can be performed and hence zest of a game is further increased.

In an exemplary embodiment, in the virtual space, the first virtual camera is set at a position higher than positions of the first object and the second virtual camera.

According to the exemplary embodiment, by setting the first virtual camera at a position higher than the position of the second virtual camera, an overhead view image can be obtained and displayed, so that zest of a game is increased owing to different viewpoints.

In an exemplary embodiment, a case where the position data of the operation apparatus is in the first range refers to a case where an orientation of a display surface of the display portion is close to horizontal, and a case where it is in the second range refers to a case where an orientation of the display surface of the display portion is close to vertical.

According to the exemplary embodiment, since the viewpoint mode can be switched between a case where an orientation of the display surface of the display portion is close to horizontal and a case where an orientation of the display surface of the display portion is close to vertical, a desired viewpoint mode can readily be set and operability is good.

An exemplary embodiment provides a non-transitory storage medium encoded with a computer readable program for controlling an information processing unit and executable by a computer of the information processing unit. The information processing unit operates in cooperation with an operation apparatus having a display portion for displaying information. The program for controlling an information processing unit includes instructions for accepting a user's operation input, instructions for obtaining first position data of an axis of a prescribed direction in a reference direction in a space where the operation apparatus is present and second position data around an axis of a second prescribed direction, and instructions for performing game processing in accordance with the accepted operation input when the obtained first position data of the operation apparatus is in a first range and performing game processing in accordance with the accepted operation input and the obtained second position data of the operation apparatus when the obtained first position data of the operation apparatus is in a second range.

According to the exemplary embodiment, when the first position data of the operation apparatus is in the first range, game processing in accordance with the accepted operation input is performed, and when the first position data of the operation apparatus is in the second range, game processing in accordance with the accepted operation input and the obtained second position data of the operation apparatus is performed. Namely, since inputs accepted in performing game processing in accordance with the operation position of the operation apparatus are different, zest of a game is increased.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an exemplary illustrative non-limiting plan view showing appearance of a game device 10.

FIG. 2 shows an exemplary illustrative non-limiting block diagram showing an internal configuration of game device 10.

FIG. 3 shows an exemplary illustrative non-limiting diagram illustrating a three-dimensional world coordinate system and a camera coordinate system representing a game space (a virtual space) according to an exemplary embodiment.

FIG. 4 shows an exemplary illustrative non-limiting diagram showing one example of a virtual camera arranged in the virtual space according to the exemplary embodiment.

FIG. 5 shows an exemplary illustrative non-limiting diagram illustrating a user's operation position of game device 10 according to the exemplary embodiment.

FIG. 6 shows an exemplary illustrative non-limiting diagram illustrating arrangement of a virtual camera in a first user viewpoint mode and a second user viewpoint mode according to the exemplary embodiment.

FIG. 7 shows an exemplary illustrative non-limiting diagram illustrating a scheme for setting an orientation (a direction of line of sight) of a player object at the time of service and during stroke according to the exemplary embodiment.

FIG. 8 shows an exemplary illustrative non-limiting diagram illustrating one example of a manner of user's operation of game device 10 according to the exemplary embodiment.

FIG. 9 shows an exemplary illustrative non-limiting diagram illustrating orientations of a player object OBJ1 and the virtual camera in a case where game device 10 is rotated according to the exemplary embodiment.

FIG. 10 shows an exemplary illustrative non-limiting diagram illustrating an extent to which an orientation (a direction of line of sight) of the player object at the time of service and during stroke can be changed according to the exemplary embodiment.

FIG. 11 shows an exemplary illustrative non-limiting diagram illustrating relation between an amount of operation and an angle of rotation in a case where an orientation (a direction of line of sight) of the player object is moved according to the exemplary embodiment.

FIG. 12 shows an exemplary illustrative non-limiting diagram illustrating control of movement of a ball object according to the exemplary embodiment.

FIG. 13 shows an exemplary illustrative non-limiting diagram illustrating a specific example of game processing according to the exemplary embodiment.

FIG. 14 shows an exemplary illustrative non-limiting diagram illustrating data stored in a main memory 32 according to the exemplary embodiment.

FIG. 15 shows an exemplary illustrative non-limiting diagram illustrating main flow of performing game processing according to the exemplary embodiment.

FIG. 16 shows an exemplary illustrative non-limiting flowchart illustrating viewpoint setting processing according to the exemplary embodiment.

FIG. 17 shows an exemplary illustrative non-limiting flowchart illustrating input acceptance processing according to the exemplary embodiment.

FIG. 18 shows an exemplary illustrative non-limiting flowchart illustrating player object movement processing according to the exemplary embodiment.

FIG. 19 shows an exemplary illustrative non-limiting flowchart illustrating processing for setting a direction of line of sight of player object OBJ1 according to the exemplary embodiment.

FIG. 20 shows an exemplary illustrative non-limiting flowchart illustrating ball object movement processing according to the exemplary embodiment.

FIG. 21 shows an exemplary illustrative non-limiting flowchart illustrating player object movement processing according to an exemplary embodiment.

FIG. 22 shows an exemplary illustrative non-limiting diagram illustrating a configuration of a game system according to an exemplary embodiment.

### DETAILED DESCRIPTION OF NON-LIMITING EXAMPLE EMBODIMENTS

This embodiment will be described in detail with reference to the drawings. The same or corresponding elements in the drawings have the same reference characters allotted and description thereof will not be repeated.

[Configuration of Appearance of Game Device]

A game device according to one example (one embodiment) will be described below.

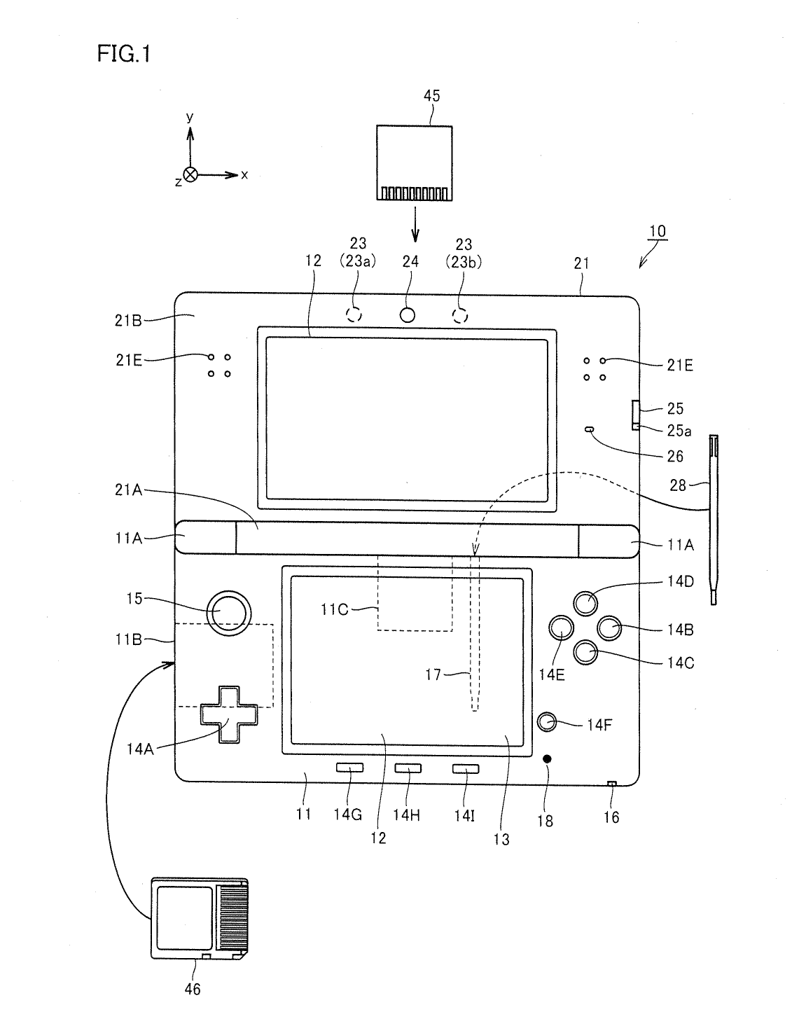

Referring to FIG. 1, a game device 10 is a portable game device and it is structured to be foldable. FIG. 1 shows a front view of game device 10 in an opened state (open state). Game device 10 is capable of picking up an image with the use of an image pick-up portion, displaying a picked up image on a screen, or saving data of the picked up image. In addition, game device 10 is capable of executing a game program stored in an exchangeable memory card or received from a server or other game devices and displaying on the screen an image generated through computer graphics processing of an image or the like picked up by a virtual camera set in a virtual space.

As shown in FIG. 1, game device 10 has a lower housing 11 and an upper housing 21. Lower housing 11 and upper housing 21 are connected to each other to allow opening and closing (to be foldable).

(Description of Lower Housing)

Initially, a construction of lower housing 11 will be described. As shown in FIG. 1, lower housing 11 is provided with a lower LCD (Liquid Crystal Display) 12, a touch panel 13, operation buttons 14A to 14I, a slide pad 15, LEDs 16A to 16B, an insertion port 17, and a microphone hole 18, details of which will be described below.

As shown in FIG. 1, lower LCD 12 is accommodated in lower housing 11. The number of pixels of lower LCD 12 may be set, for example, to 320 dots×240 dots (horizontal×vertical). Unlike an upper LCD 22 which will be described later, lower LCD 12 is a display for two-dimensionally displaying an image (unable to provide stereoscopic display). Though an LCD is employed as a display in the present embodiment, for example, any other display such as a display making use of EL (Electro Luminescence) may be made use of. In addition, a display having any resolution can be made use of as lower LCD 12.

As shown in FIG. 1, game device 10 includes touch panel 13 as an input device. Touch panel 13 is attached on a screen of lower LCD 12. In the present embodiment, touch panel 13 is a resistive film type touch panel, however, the touch panel is not limited to the resistive film type, and a touch panel of any type such as a capacitance type can be employed. In the present embodiment, a touch panel having resolution (detection accuracy) as high as that of lower LCD 12 is made use of as touch panel 13, however, touch panel 13 does not necessarily have to be equal in resolution to lower LCD 12. In addition, insertion port 17 (a dotted line shown in FIG. 1) is provided in an upper side surface of lower housing 11. Insertion port 17 can accommodate a touch pen 28 used for performing an operation onto touch panel 13. Though input to touch panel 13 is normally made by using touch pen 28, input on touch panel 13 can also be made with a user's finger, without limited to touch pen 28.

Operation buttons 14A to 14I are input devices for providing a prescribed input. As shown in FIG. 1, on an inner surface (a main surface) of lower housing 11, a cross-shaped button 14A (a direction input button 14A), a button 14B, a button 14C, a button 14D, a button 14E, a power button 14F, a select button 14G, a HOME button 14H, and a start button 14I are provided. Cross-shaped button 14A has a button in a cross-shape for indicating up/down/left/right directions. Functions in accordance with a program executed by game device 10 are allocated to buttons 14A to 14E, select button 14G, HOME button 14K, and start button 14I as appropriate. For example, cross-shaped button 14A is used for a selection operation or the like, and operation buttons 14B to 14E are used, for example, for an enter operation, a cancellation operation, and the like. Power button 14F is used for turning on/off power of game device 10. Further, in the present example, by way of example, button 14B is used for a shot input button for hitting a ball object with a racket (hitting a shot) in game processing which will be described later.

Slide pad 15 is a device indicating a direction. A key top of slide pad 15 is constructed to slide in parallel to the inner surface of lower housing 11. Slide pad 15 functions in accordance with a program executed by game device 10. For example, when game device 10 executes a game in which a prescribed object appears in a three-dimensional virtual space, slide pad 15 functions as an input device for moving the prescribed object in the three-dimensional virtual space. In this case, the prescribed object is moved in a direction in which the key top of slide pad 15 slides. It is noted that a component allowing an analog input based on inclination by a prescribed amount in any of up, down, left, right, and diagonal directions may be employed as slide pad 15. In the present example, by way of example, it is assumed that slide pad 15 is used as direction indication input means for movement or the like of a player object in game processing which will be described later. In addition, it is assumed that slide pad 15 is also used as indication input means for correcting a direction of movement of a ball object.

It is noted that cross-shaped button 14A can also be used instead of slide pad 15.

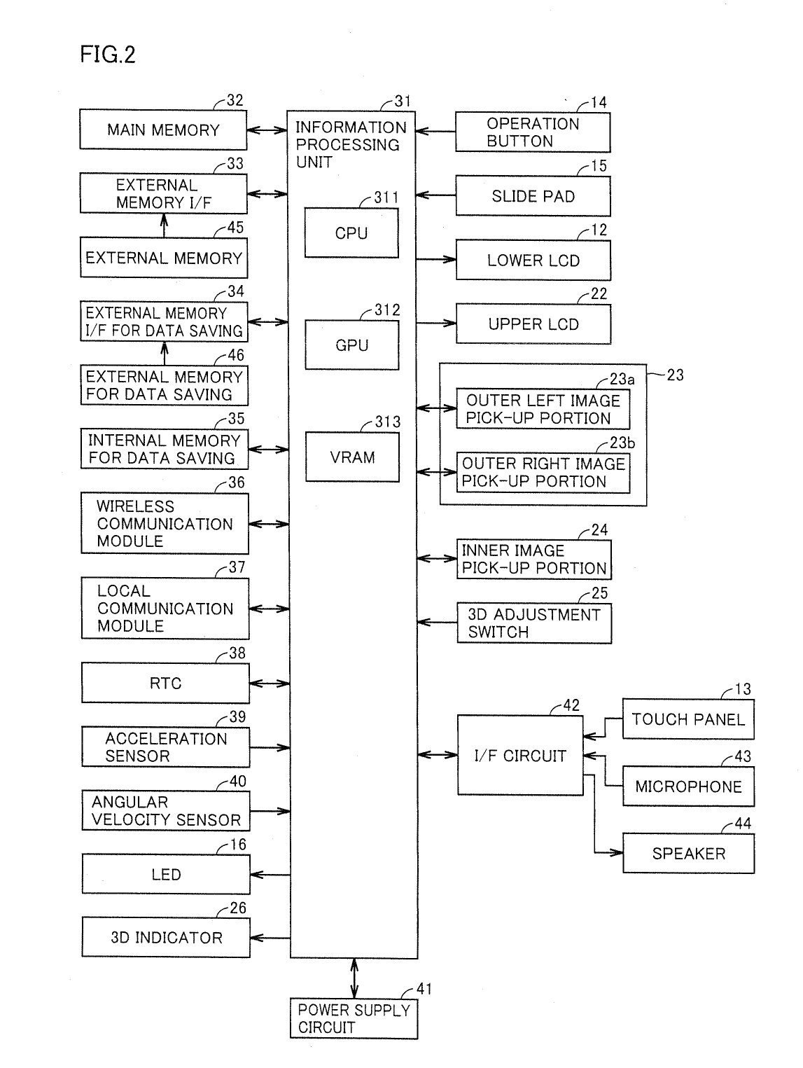

Further, microphone hole 18 is provided in the inner surface of lower housing 11. A microphone (see FIG. 2) serving as an audio input device which will be described later is provided in microphone hole 18 and the microphone senses sound outside game device 10.

Though not shown, an L button 14J and an R button 14K are provided on the upper side surface of lower housing 11. L button 14J and R button 14K can function, for example, as a shutter button of the image pick-up portion (a shooting indication button). Further, though not shown, a sound volume button 14L is provided on a left side surface of lower housing 11. Sound volume button 14L is used for adjusting volume of a speaker provided in game device 10.

Furthermore, as shown in FIG. 1, a cover portion 11B that can be opened and closed is provided in the left side surface of lower housing 11. On an inner side of this cover portion 11B, a connector (not shown) for electrical connection between game device 10 and an external memory for data saving 46 is provided. External memory for data saving 46 is removably attached to the connector. External memory for data saving 46 is used, for example, for storing (saving) data of an image picked up by game device 10.

In addition, as shown in FIG. 1, an insertion port 11C for inserting an external memory 45 recording a game program is provided in the upper side surface of lower housing 11, and a connector (not shown) for removably electrically connecting external memory 45 is provided in that insertion port 11C. As external memory 45 is connected to game device 10, a prescribed game program is executed.

Moreover, as shown in FIG. 1, first LED 16A notifying a user of an ON/OFF state of power of game device 10 is provided in a lower side surface of lower housing 11. Further, though not shown, second LED 16B notifying a user of a state of establishment of wireless communication of game device 10 is provided in a right side surface of lower housing 11. Game device 10 can establish wireless communication with other equipment and second LED 16B illuminates when wireless communication is established. Game device 10 has a function to connect to wireless LAN, for example, under a scheme complying with IEEE 802.11b/g standards. A wireless switch 19 activating/inactivating this wireless communication function (not shown) is provided in the right side surface of lower housing 11.

Though not shown, a rechargeable battery serving as a power supply of game device 10 is accommodated in lower housing 11, and the battery can be charged through a terminal provided in a side surface (for example, the upper side surface) of lower housing 11.

(Description of Upper Housing)

A construction of upper housing 21 will now be described. As shown in FIG. 1, upper housing 21 is provided with upper LCD (Liquid Crystal Display) 22, an outer image pick-up portion 23 (an outer image pick-up portion (left) 23a and an outer image pick-up portion (right) 23b), an inner image pick-up portion 24, a 3D adjustment switch 25, and a 3D indicator 26, details of which will be described below.

As shown in FIG. 1, upper LCD 22 is accommodated in upper housing 21. The number of pixels of upper LCD 22 may be set, for example, to 800 dots×240 dots (horizontal×vertical). Though an LCD is employed as upper LCD 22 in the present embodiment, for example, a display making use of EL (Electro Luminescence) may be made use of. In addition, a display having any resolution can be made use of as upper LCD 22.

Upper LCD 22 is a display capable of displaying an image that can stereoscopically be viewed. In addition, in the present embodiment, an image for left eye and an image for right eye are displayed by using substantially the same display region. Specifically, a display is adapted to a scheme in which an image for left eye and an image for right eye are alternately displayed in a lateral direction in a prescribed unit (for example, one column by one column). Alternatively, a display may be adapted to a scheme in which an image for left eye and an image for right eye are alternately displayed in a time-divided manner. In addition, in the present embodiment, a display can allow stereoscopic vision with naked eyes. Then, a lenticular type or parallax barrier type display is used such that an image for left eye and an image for right eye alternately displayed in a lateral direction can be viewed as decomposed by left and right eyes respectively. In the present embodiment, it is assumed that a parallax barrier type display is employed as upper LCD 22. Upper LCD 22 displays an image that can stereoscopically be viewed with naked eyes (hereinafter referred to as a stereoscopic image) by using an image for right eye and an image for left eye. Namely, upper LCD 22 can display a stereoscopic image with stereoscopic effect as felt by a user by having the user's left and right eyes visually recognize the image for left eye and the image for right eye respectively with the use of a parallax barrier. In addition, upper LCD 22 can inactivate the parallax barrier above, and when the parallax barrier is inactivated, an image can two-dimensionally be displayed (a two-dimensional image in a sense contrary to stereoscopic vision described above can be displayed; that is, such a display mode that the same displayed image is viewed both by right and left eyes). Thus, upper LCD 22 is a display capable of switching between stereoscopic display for displaying a stereoscopic image that can stereoscopically be viewed (a stereoscopic display mode) and two-dimensional display for two-dimensionally displaying an image (displaying a two-dimensional image) (a two-dimensional display mode). Switching of display can be made by processing by a CPU 311 or by 3D adjustment switch 25 which will be described later.

Outer image pick-up portion 23 is a collective denotation of two image pick-up portions (23a and 23b) provided on an outer surface (a rear surface opposite to the main surface where upper LCD 22 is provided) 21D of upper housing 21. Directions of image pick-up of outer image pick-up portion (left) 23a and outer image pick-up portion (right) 23b are both a direction of normal extending outward from outer surface 21D. Outer image pick-up portion (left) 23a and outer image pick-up portion (right) 23b can be used as stereo cameras by means of a program executed by game device 10. Outer image pick-up portion (left) 23a and outer image pick-up portion (right) 23b each include image pick-up elements (for example, a CCD image sensor, a CMOS image sensor, or the like) having prescribed common resolution and a lens. A lens may have a zoom mechanism.

Inner image pick-up portion 24 is an image pick-up portion provided in an inner surface (main surface) 21B of upper housing 21 and having a direction of normal extending inward from the inner surface as a direction of image pick-up. Inner image pick-up portion 24 includes image pick-up elements (for example, a CCD image sensor, a CMOS image sensor, or the like) having prescribed resolution and a lens. A lens may have a zoom mechanism.

Three-dimension adjustment switch 25 is a slide switch and it is a switch used for switching between display modes of upper LCD 22 as described above. Three-dimension adjustment switch 25 is used for adjusting stereoscopic effect of a stereoscopic image displayed on upper LCD 22. As will clearly be described later, however, in the present embodiment, by way of example, regardless of 3D adjustment switch 25, an image displayed on upper LCD 22 is switched between a stereoscopic image and a two-dimensional image in accordance with an angle of inclination of lower housing 11. Specifically, when game device 10 is set at an angle close to perpendicular, that is, when an angle of inclination at which lower housing 11 is inclined in a horizontal plane increases and exceeds a threshold value, a two-dimensional image is displayed.

Three-dimension indicator 26 indicates whether upper LCD 22 is in a stereoscopic display mode or not. Three-dimension indicator 26 is implemented by an LED and it illuminates when the stereoscopic display mode of upper LCD 22 is active. It is noted that 3D indicator 26 may illuminate only when upper LCD 22 is in the stereoscopic display mode and program processing for displaying a stereoscopic image is being performed. As shown in FIG. 1, 3D indicator 26 is provided in the inner surface of upper housing 21, in the vicinity of the screen of upper LCD 22. Therefore, when the user looks straight the screen of upper LCD 22, the user readily visually recognizes 3D indicator 26. Therefore, even when the user is visually recognizing the screen of upper LCD 22, the user can readily recognize the display mode of upper LCD 22.

In addition, a speaker hole 21E is provided in the inner surface of upper housing 21. Voice and sound from a speaker 44 which will be described later is output through this speaker hole 21E.

[Internal Configuration of Game Device 10]

An internal electrical configuration of game device 10 will now be described with reference to FIG. 2. As shown in FIG. 2, game device 10 includes, in addition to each portion described above, such electronic components as an information processing unit 31, a main memory 32, an external memory interface (external memory I/F) 33, an external memory I/F for data saving 34, internal memory for data saving 35, a wireless communication module 36, a local communication module 37, a real time clock (RTC) 38, an acceleration sensor 39, an angular velocity sensor 40, and a power supply circuit 41. These electronic components are accommodated in lower housing 11 as mounted on an electronic circuit board (or may be accommodated in upper housing 21).

Information processing unit 31 is information processing means including CPU (Central Processing Unit) 311 for executing a prescribed program, a GPU (Graphics Processing Unit) 312 for image processing, and the like. CPU 311 of information processing unit 31 performs processing in accordance with a program by executing the program stored in a memory in game device 10 (for example, external memory 45 connected to external memory I/F 33 or internal memory for data saving 35). It is noted that a program executed by CPU 311 of information processing unit 31 may be obtained from other equipment through communication with other equipment. In addition, information processing unit 31 includes a VRAM (Video RAM) 313. GPU 312 of information processing unit 31 generates an image in response to an instruction from CPU 311 of information processing unit 31 and renders the image in VRAM 313. Then, GPU 312 of information processing unit 31 outputs the image rendered in VRAM 313 to upper LCD 22 and/or lower LCD 12, so that upper LCD 22 and/or lower LCD 12 display(s) the image.

Main memory 32, external memory I/F 33, external memory I/F for data saving 34, and internal memory for data saving 35 are connected to information processing unit 31. External memory I/F 33 is an interface for removably connecting external memory 45. In addition, external memory I/F for data saving 34 is an interface for removably connecting external memory for data saving 46.

Main memory 32 is volatile storage means used as a work area or a buffer area of (CPU 311 of) information processing unit 31. Namely, main memory 32 temporarily stores various types of data used for processing based on the program above or temporarily stores a program obtained from the outside (external memory 45, other equipment, and the like). In the present embodiment, for example, a PSRAM (Pseudo-SRAM) is employed as main memory 32.

External memory 45 is non-volatile storage means for storing a program executed by information processing unit 31. External memory 45 is implemented, for example, by a read-only semiconductor memory. As external memory 45 is connected to external memory I/F 33, information processing unit 31 can read a program stored in external memory 45. As information processing unit 31 executes the read program, prescribed processing is performed. External memory for data saving 46 is implemented by a non-volatile readable and writable memory (for example, a NAND type flash memory) and it is used for storing prescribed data. For example, external memory for data saving 46 stores an image picked up by outer image pick-up portion 23 or an image picked up by other equipment. As external memory for data saving 46 is connected to external memory I/F for data saving 34, information processing unit 31 reads an image stored in external memory for data saving 46 so that upper LCD 22 and/or lower LCD 12 can display the image.

Internal memory for data saving 35 is implemented by a non-volatile readable and writable memory (for example, a NAND type flash memory) and used for storing prescribed data. For example, internal memory for data saving 35 stores data or a program downloaded through wireless communication via wireless communication module 36.

Wireless communication module 36 has a function to connect to wireless LAN, for example, under a scheme complying with IEEE 802.11b/g standards. In addition, local communication module 37 has a function to establish wireless communication with a game device of the same type under a prescribed communication scheme (for example, communication based on an original protocol or infrared communication). Wireless communication module 36 and local communication module 37 are connected to information processing unit 31. Information processing unit 31 can transmit and receive data to and from other equipment over the Internet through wireless communication module 36 or transmit and receive data to and from another game device of the same type through local communication module 37.

In addition, RTC 38 and power supply circuit 41 are connected to information processing unit 31. RTC 38 counts time and outputs the time to information processing unit 31. Information processing unit 31 calculates the current time (date) based on the time counted by RTC 38.

Acceleration sensor 39 representing one type of an inertial sensor is further connected to information processing unit 31. Acceleration sensor 39 senses magnitude of acceleration in a linear direction (linear acceleration) along a three-axis (xyz-axis) direction. Acceleration sensor 39 is provided inside lower housing 11. As shown in FIG. 1, acceleration sensor 39 senses magnitude of linear acceleration in each axis, with a direction of a long side of lower housing 11 being defined as an x axis, a direction of a short side of lower housing 11 being defined as a y axis, and a direction perpendicular to the inner surface (main surface) of lower housing 11 being defined as a z axis. Though acceleration sensor 39 is assumed as being implemented, for example, by a capacitance type acceleration sensor, an acceleration sensor of other types may be employed. Alternatively, acceleration sensor 39 may be an acceleration sensor sensing a one-axis or two-axis direction. Information processing unit 31 can receive position data (acceleration data) indicating acceleration sensed by acceleration sensor 39 and sense a position of game device 10.

For example, in a static state, that is, in a case where processing is performed assuming that acceleration detected by acceleration sensor 39 is only acceleration of gravity, whether a position of game device 10 (in the present example, mainly the z axis perpendicular to the inner surface (main surface) of lower housing 11) is inclined in a direction of gravity or not or an extent of inclination can be known based on the detected acceleration data. Specifically, with a state that an axis of detection by the acceleration sensor extends in a vertically downward direction being defined as the reference, whether the game device is inclined or not can be known only based on whether 1 G (acceleration of gravity) is applied or not, and an extent of inclination can be known based on magnitude thereof.

In a case of a multi-axis acceleration sensor, to which extent the game device is inclined in the direction of gravity can be known in further detail by further subjecting data on acceleration in each axis to processing. Even based on the premise that acceleration sensor 39 is in a dynamic state, inclination in the direction of gravity can be known by eliminating acceleration in accordance with motion of the acceleration sensor through prescribed processing.

Angular velocity sensor (a gyro sensor) 40 representing one type of an inertial sensor is connected to information processing unit 31. Angular velocity sensor 40 senses an angular velocity produced around three axes (in the present embodiment, xyz axes) of game device 10 and outputs position data (angular velocity data) indicating the sensed angular velocity to information processing unit 31. Angular velocity sensor 40 is provided, for example, in lower housing 11. Information processing unit 31 calculates motion of game device 10 as it receives the angular velocity data output from angular velocity sensor 40.

In the present example, in sensing a position of operation of game device 10, acceleration sensor 39 is employed by way of example. Specifically, it is assumed that to which extent the direction of the z axis of game device 10 (the direction perpendicular to the inner surface (main surface) of lower housing 11) is inclined in the direction of gravity, that is, an angle of inclination, is calculated based on the acceleration data, and a position is sensed based on the angle of inclination.

Alternatively, in sensing motion of game device 10, angular velocity sensor 40 is employed by way of example. Specifically, it is assumed that an angular velocity produced around the direction of gravity of game device 10 is calculated based on the angular velocity data, and to which extent the game device has rotated in the reference, that is, the angle of rotation (motion), is sensed based on the angular velocity.

Power supply circuit 41 controls electric power from a power supply provided in game device 10 (the rechargeable battery above accommodated in lower housing 11) and causes supply of electric power to each component of game device 10.

In addition, an I/F circuit 42 is connected to information processing unit 31. A microphone 43 and speaker 44 are connected to I/F circuit 42. Specifically, speaker 44 is connected to I/F circuit 42 through a not-shown amplifier. Microphone 43 senses user's voice and sound and outputs an audio signal to I/F circuit 42. The amplifier amplifies the audio signal from I/F circuit 42 and causes speaker 44 to output the voice and sound. In addition, touch panel 13 described above is also connected to I/F circuit 42. I/F circuit 42 includes an audio control circuit for controlling microphone 43 and speaker 44 (amplifier) and a touch panel control circuit for controlling the touch panel. The audio control circuit carries out A/D conversion and D/A conversion of an audio signal or converts an audio signal to audio data in a prescribed format. The touch panel control circuit generates touch position data in a prescribed format based on a signal from touch panel 13 and outputs the data to information processing unit 31. The touch position data indicates a coordinate at a position where an input has been made onto an input surface of touch panel 13.

Operation button 14 is constituted of operation buttons 14A to 14L above and connected to information processing unit 31. In addition, slide pad 15 is connected to information processing unit 31.

A status of input onto operation buttons 14A to 14I (whether a button has been pressed or not) or operation data indicating a direction indication of slide is output from operation button 14 or slide pad 15 to information processing unit 31. As information processing unit 31 obtains operation data from operation button 14 or slide pad 15, it performs processing in accordance with the input to operation buttons 14A to 14L above or slide pad 15.

It is noted that CPU 311 obtains operation data from operation button 14 or slide pad 15 once in a prescribed period of time. Alternatively, inputs from both of operation button 14 and slide pad 15 can also be accepted at a prescribed time.

Lower LCD 12 and upper LCD 22 are connected to information processing unit 31. Lower LCD 12 and upper LCD 22 each display an image in response to an instruction from (GPU 312 of) information processing unit 31. In the present embodiment, information processing unit 31 causes upper LCD 22 to display a stereoscopic image (an image that can stereoscopically be viewed).

Specifically, information processing unit 31 is connected an LCD controller (not shown) of upper LCD 22 and controls the LCD controller to turn ON/OFF the parallax barrier. When the parallax barrier of upper LCD 22 is turned ON, an image for right eye and an image for left eye stored in VRAM 313 of information processing unit 31 are output to upper LCD 22. More specifically, the LCD controller reads the image for right eye and the image for left eye from VRAM 313 by alternately repeating processing for reading pixel data for one line in a vertical direction with regard to the image for right eye and processing for reading pixel data for one line in the vertical direction with regard to the image for left eye. Thus, the image for right eye and the image for left eye are each divided into strip-like images in which pixels are aligned vertically for each one line, and an image in which strip-like images of the image for right eye and strip-like images of the image for left eye as divided are alternately arranged is displayed on the screen of upper LCD 22. Then, as the image is visually recognized by the user through the parallax barrier of upper LCD 22, the user's right and left eyes visually recognize the image for right eye and the image for left eye respectively.

Outer image pick-up portion 23 and inner image pick-up portion 24 are connected to information processing unit 31. Outer image pick-up portion 23 and inner image pick-up portion 24 each pick up an image in response to an instruction from information processing unit 31 and output data of the picked-up image to information processing unit 31.

Three-dimension adjustment switch 25 is connected to information processing unit 31. Three-dimension adjustment switch 25 transmits an electric signal in accordance with a position of a slider 25a to information processing unit 31.

In addition, 3D indicator 26 is connected to information processing unit 31. Information processing unit 31 controls illumination of 3D indicator 26. For example, in a case where upper LCD 22 is in the stereoscopic display mode, information processing unit 31 causes 3D indicator 26 to illuminate. The foregoing is the description of the internal configuration of game device 10.

[Outlines of Information Processing]

Outlines of information processing will now be described. By way of example of information processing, game device 10 is assumed to perform game processing. In the present example, a case where a tennis game is played by way of example of game processing will be described. Game processing in the present embodiment is performed as a prescribed game program is executed in game device 10.

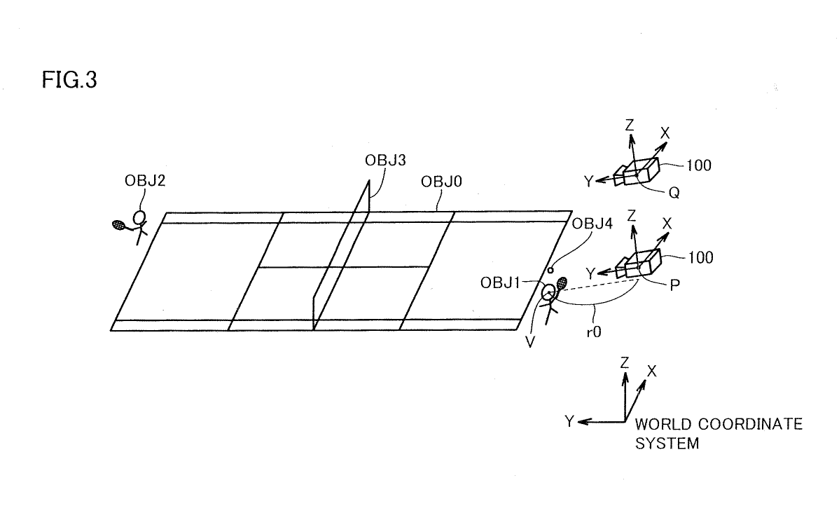

Referring to FIG. 3, here, a case where a tennis court object OBJ0, a net object OBJ3, a player object OBJ1, an opposition object OBJ2, and a ball object OBJ4 are arranged at initial coordinates in a three-dimensional world coordinate system is shown. It is noted that a case where each of player object OBJ1 and opposition object OBJ2 has a tennis racket is shown.

Then, a case where the user can use slide pad 15 to operate operable player object OBJ1 and to play a tennis game with opposition object OBJ2 in the tennis court in the virtual space based on prescribed rules of the tennis game is shown. Specifically, prescribed game processing proceeds by repeating what is called services and strokes as necessary.

Here, positions of two virtual cameras 100 are shown. A position of one virtual camera 100 is arranged at a position distant by a prescribed distance r0 from a coordinate V representing the position of player object OBJ1 and the virtual camera shoots player object OBJ1 or the like. Here, a case where virtual camera 100 is arranged at a coordinate P in the position of player object OBJ1 (a first user viewpoint mode) is shown.

A position of another virtual camera 100 is provided above coordinate P (a positive direction in a Z axis of the world coordinate system) and the virtual camera is arranged at a position allowing entire tennis court object OBJ0 including player object OBJ1 and opposition object OBJ2 to be looked down upon. Here, a case where virtual camera 100 is arranged at a coordinate Q (an overhead viewpoint mode) is shown. It is noted that, in the present example, in the case of the overhead viewpoint mode, it is assumed that virtual camera 100 is fixed at a fixed point, however, it may be moved to another position at which the entirety can be looked down upon without being fixed.

Though description will be given later, in the present example, a position of virtual camera 100 is switched in accordance with a position of game device 10. In addition, the number of virtual cameras is also switched. In this regard, in a case where acceleration sensor 39 is used to calculate an angle of the direction of the z axis of game device 10 inclined in the direction of gravity (an angle of inclination) and the angle of inclination in the direction of gravity is smaller than a prescribed angle, for example, the overhead viewpoint mode in which a coordinate position of virtual camera 100 is set at coordinate Q is set. Though a case where only a single virtual camera 100 is provided at coordinate Q is shown here, it is assumed that two virtual cameras are provided in order to permit a stereoscopic image (not shown).

On the other hand, when an angle of inclination of the direction of the z axis of game device 10 in the direction of gravity is equal to or greater than a first prescribed angle, for example, the first user viewpoint mode in which a coordinate position of virtual camera 100 is set at coordinate P is set. Though description will be given later, when an angle of inclination of the direction of the z axis of game device 10 in the direction of gravity is equal to or greater than a second prescribed angle, a second user viewpoint mode is set.

In the case of the overhead viewpoint mode, since the virtual camera is arranged at a position where entire tennis court object OBJ0 including player object OBJ1 and opposition object OBJ2 can be looked down upon, a game operation can be performed at a viewpoint at which the entire state can be grasped. It is noted that, since two virtual cameras are arranged in the case of the overhead viewpoint mode, a stereoscopic image is displayed on upper LCD 22.

In the case of the user viewpoint mode, since the virtual camera is arranged behind player object OBJ1, a game operation can be performed from a viewpoint of player object OBJ1. In the case of the user viewpoint mode, since a single virtual camera is arranged, a two-dimensional image is displayed on upper LCD 22. By doing so, a screen is readily viewed even when input based on an angle of rotation is made. In another embodiment, however, a stereoscopic image may be displayed also in the user viewpoint mode, depending on the purpose of the game or an operation method.

The virtual camera is arranged such that an angle of depression and an angle of elevation of the virtual camera with player object OBJ1 serving as the reference are different between the first user viewpoint mode and the second user viewpoint mode.

Further, in the case of the user viewpoint mode, virtual camera 100 is arranged at a position in accordance with arrangement of player object OBJ1. In the present example, it is assumed that arrangement is such that an orientation (a direction of line of sight) of player object OBJ1 on an XY plane is the same as a direction of shooting of the virtual camera. It is noted that this direction of line of sight is used as a direction parameter for controlling a reference direction of travel of the ball object in a case where ball object OBJ4 is hit.

A stereoscopic image displayed on upper LCD 22 will now be described.

In the present embodiment, as described above, upper LCD 22 can display a stereoscopic image. It is assumed that a stereoscopic image in the present embodiment is generated by using two virtual cameras arranged in the virtual space and having respective directions of image pick-up set in the case of the overhead viewpoint mode as described above.

The two virtual cameras arranged in the virtual space are used for generating the image for left eye and the image for right eye described above, respectively. One of the two virtual cameras arranged in the virtual space is arranged as a left virtual camera for generating an image for left eye, and the other thereof is arranged as a right virtual camera for generating an image for right eye.

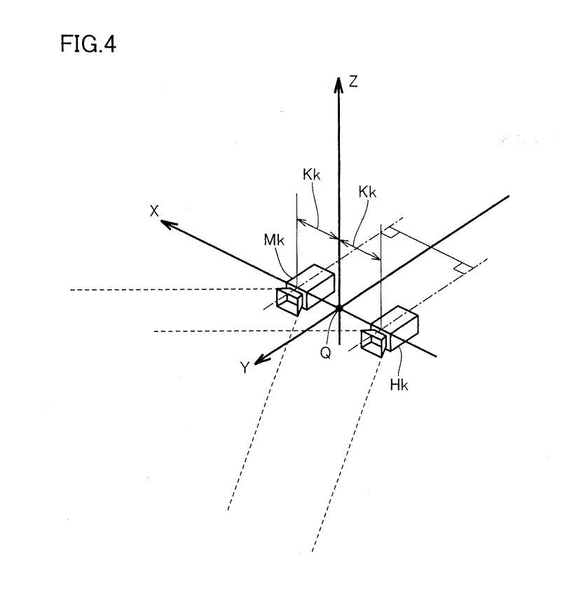

Referring to FIG. 4, in the present embodiment, by way of example, a left virtual camera Hk and a right virtual camera Mk are moved to and arranged at positions each at a distance Kk (hereinafter referred to as a virtual camera distance Kk) from an origin Q in the virtual space to each of a positive direction and a negative direction of an X axis. Therefore, a distance between left virtual camera Hk and right virtual camera Mk is twice as large as virtual camera distance Kk. In addition, directions of image pick-up of left virtual camera Hk and right virtual camera Mk are parallel to each other. Thus, left virtual camera Hk and right virtual camera Mk in such positional relation that a distance therebetween is 2Kk and the directions of image pick-up are parallel to each other are arranged with an origin in the virtual space being the center. Then, an image for left eye is generated as an image obtained by picking up an image of the virtual space with left virtual camera Hk and an image for right eye is generated as an image obtained by picking up an image of the virtual space with right virtual camera Mk. Since a distance between left virtual camera Hk and right virtual camera Mk is 2Kk, the image for left eye and the image for right eye are generated as images having parallax corresponding to that distance. Therefore, the image for left eye and the image for right eye are displayed on upper LCD 22 as a stereoscopic image having parallax. Virtual camera distance Kk can be adjusted by 3D adjustment switch 25.

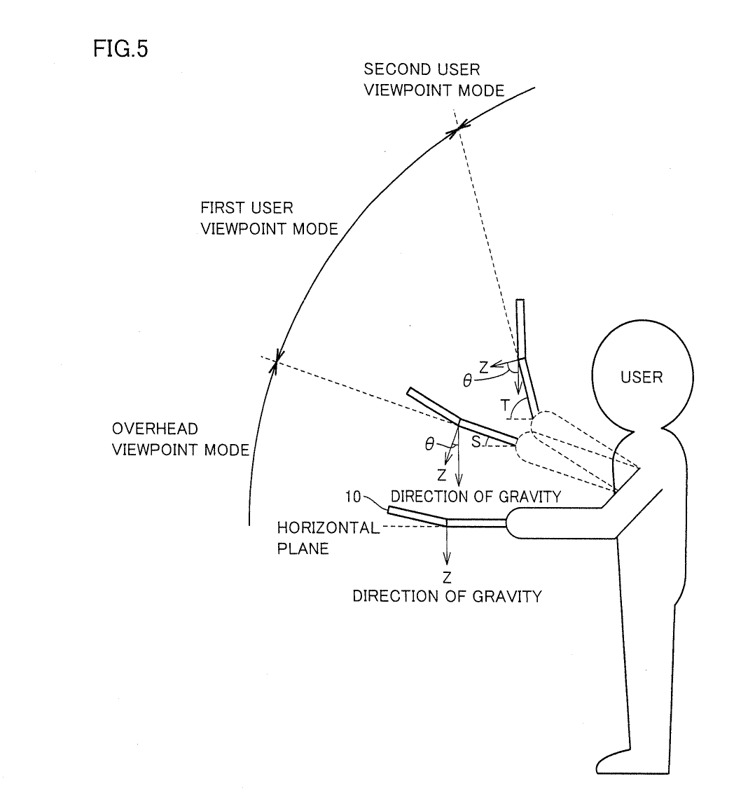

Referring to FIG. 5, in the present example, an angle in the direction of the z axis of game device 10 (an angle of inclination θ) with the direction of gravity being defined as the reference direction is shown. It is noted that an angle clockwise with the direction of gravity being defined as the reference is assumed as positive and an angle counterclockwise is assumed as negative. Then, possible angles of inclination range from −180° to 180°. It is noted that the angle of inclination is detected by acceleration sensor 39 in the present example, as described above.

In a case where a hand holding game device 10 is placed in parallel to the horizontal plane having the direction of gravity as a perpendicular (game device 10 (mainly lower housing 11) is located in parallel to the horizontal plane), an angle of inclination at which the direction of the z axis of game device 10 is inclined in the direction of gravity is 0°.

Alternatively, in a case where the hand holding game device 10 is lifted to incline game device 10, an angle of inclination at which the direction of the z axis of game device 10 is inclined in the direction of gravity (a positive value) increases.

By way of example, in a case where angle of inclination θ is smaller than a first prescribed angle (S°) (within a range of −180°≦θ<S°), the overhead viewpoint mode is set. Namely, a case where angle of inclination θ is smaller than the first prescribed angle refers to a case where an orientation of lower LCD 12 of lower housing 11 is close to parallel to the horizontal plane. In a case where angle of inclination θ is equal to or greater than the first prescribed angle (S°) (within a range of S≦θ<T°), the first user viewpoint mode is set. Alternatively, in a case where angle of inclination θ is equal to or greater than a second prescribed angle (T°), the second user viewpoint mode is set. The case where angle of inclination θ is equal to or greater than the second prescribed angle (within a range of T°≦θ<180°) refers to a case where an orientation of lower LCD 12 of lower housing 11 is close to vertical in the horizontal plane.

Though a case where switching from the overhead viewpoint mode to the first user viewpoint mode is made with the first prescribed angle (S°) serving as a threshold value has been described in the present example, it is also possible that the threshold value for switching is not set to the same threshold value when switching to the overhead viewpoint mode is made from the first user viewpoint mode. For example, by setting a prescribed angle (R°) smaller than the first prescribed angle (S°) as a threshold value so as to prevent continuous switching around that angle, influence on user's operability can be avoided. Namely, a threshold value at which switching is made can be changed in correspondence with the current viewpoint mode. For example, in a case where the first user viewpoint mode is set, the first user viewpoint mode may be maintained while angle of inclination θ is within a range of R°≦θ<T°, and switching to the overhead viewpoint mode may be made when angle of inclination θ is set to θ<R. Though adjustment of a threshold value in the case of the overhead viewpoint mode and the first user viewpoint mode has been described, such adjustment is similarly applicable also to a case of the first user viewpoint mode and the second user viewpoint mode.

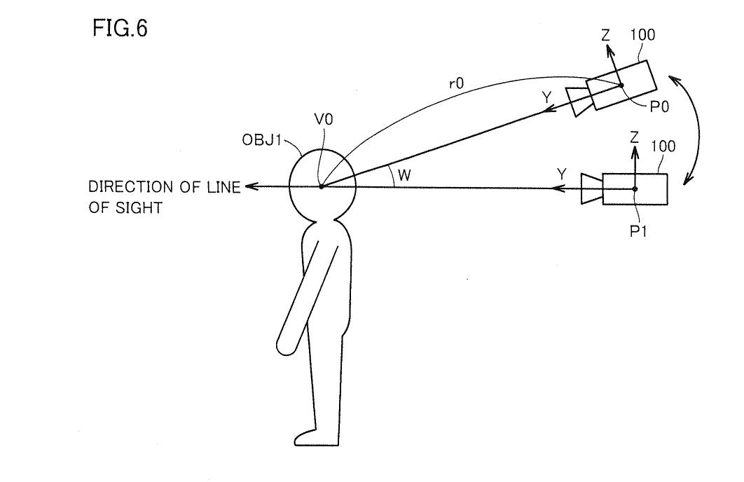

Referring to FIG. 6, a case where virtual camera 100 is arranged at a position distant by r0 from a coordinate V0 of player object OBJ1 in the world coordinate system is shown. Though description will be given later, arrangement of virtual camera 100 is determined based on a coordinate position and a direction of line of sight of player object OBJ1, and a case where the coordinate and the direction of line of sight have been determined will be described.

Virtual camera 100 is arranged at a coordinate P0 in the case of the first user viewpoint mode. Alternatively, virtual camera 100 is arranged at a coordinate P1 in the case of the second user viewpoint mode.

With coordinate V0 of player object OBJ1 being defined as the reference, coordinate P1 is located at a position distant by r0 in a horizontal direction (on the XY plane), and coordinate P0 is located at a position distant by r0 and in correspondence with an angle of elevation w° from the horizontal direction (on the XY plane) with coordinate V0 being defined as the reference.

Then, in the case of the first user viewpoint mode, a direction of shooting of virtual camera 100 is in a direction from coordinate P0 of virtual camera 100 toward coordinate V0 of the player object.

Alternatively, in the case of the second user viewpoint mode, a direction of shooting of virtual camera 100 is in a direction from coordinate P1 of virtual camera 100 toward coordinate V0 of the player object.

It is noted that, in the first and second user viewpoint modes, the direction of shooting on the XY plane is set to be the same as an orientation of player object OBJ1 (the direction of line of sight).

In the first user viewpoint mode, shooting with virtual camera 100 is carried out from a position at angle of elevation w° in the horizontal direction, whereas in the second user viewpoint mode, virtual camera 100 is positioned at a position at angle of elevation 0° for shooting. Therefore, shooting is carried out at a height in the vicinity of eyes of player object OBJ1 and hence a game operation at the viewpoint of the player is allowed. Thus, the sense of realism increases.

It is noted that a value of an angle of elevation is by way of example, without limited thereto.

(Setting of Direction of Line of Sight of Player Object OBJ1)

A scheme for setting a direction of line of sight of player object OBJ1 will now be described.

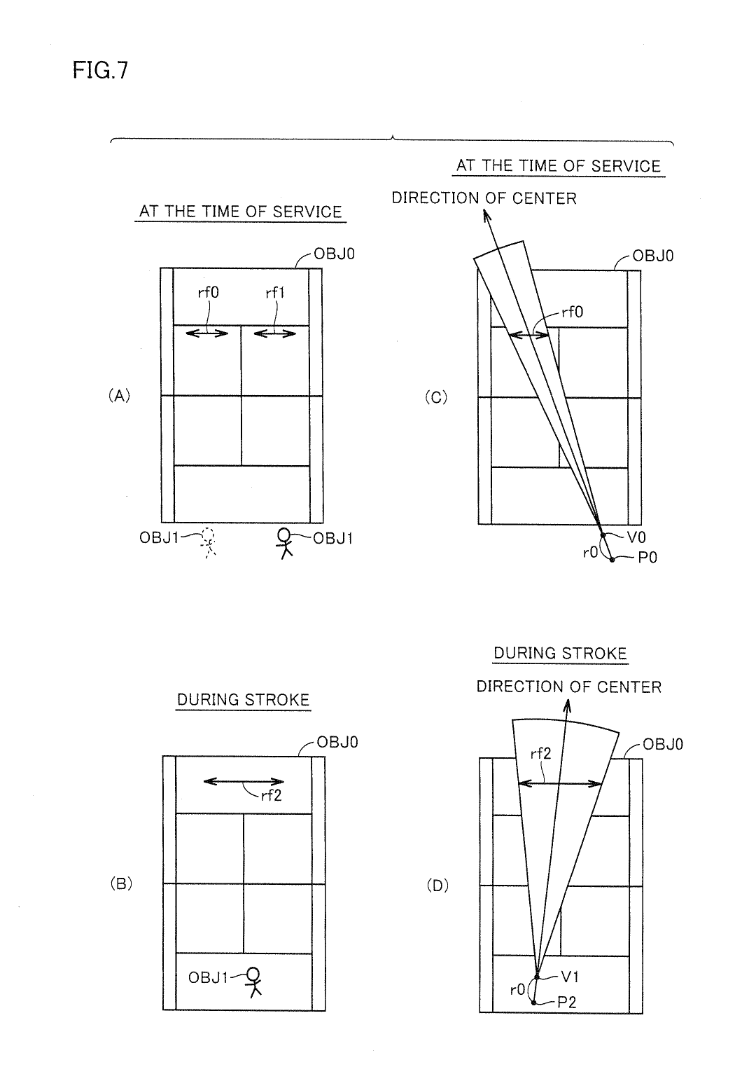

Referring to FIG. 7(A), here, reference lines rf0 and rf1 provided in tennis court object OBJ0 used for setting a direction of line of sight at the time of service are shown. It is noted that reference lines rf0 and rf1 are used for setting a direction of line of sight and the reference lines are not displayed. In addition, the reference line is switched as the tennis game proceeds. Specifically, in a case where player object OBJ1 is located in a court region on the right in tennis court object OBJ0 at the time of service, reference line rf0 is used as valid.

On the other hand, in a case where player object OBJ1 is located in a court region on the left in tennis court object OBJ0 at the time of service, reference line rf1 is used as valid. It is noted that, at the time of service, an initial position of player object OBJ1 is set in advance. In addition, during stroke, as shown in FIG. 7(B), the reference line is switched to a reference line rf2 provided in tennis court object OBJ0.

Then, FIG. 7(C) shows a scheme for setting an orientation (a direction of line of sight) of player object OBJ1 at the time of service. Specifically, a reference field of view is set from a position of player object OBJ1 by using reference line rf0. Then, the reference field of view is set like an arc so as to accommodate reference line rf0. Then, a direction of a center in an angle of the reference field of view is set as the orientation (the direction of line of sight) of player object OBJ1. Thus, movement of player object OBJ1 in accordance with a direction indication input through slide pad 15 is controlled in accordance with the orientation (the direction of line of sight) of player object OBJ1. In addition, a position of virtual camera 100 is set in accordance with a coordinate and an orientation (a direction of line of sight) of player object OBJ1. In the present example, a case where coordinate P0 where virtual camera 100 is to be arranged is set in accordance with coordinate V0 and the orientation (the direction of line of sight) of player object OBJ1 is shown.

FIG. 7(D) shows a scheme for setting an orientation (a direction of line of sight) of player object OBJ1 during stroke. Specifically, a reference field of view is set from a position of player object OBJ1 by using reference line rf2. Then, the reference field of view is set like an arc so as to accommodate reference line rf2. Then, a direction of a center in an angle of the reference field of view is set as the orientation (the direction of line of sight) of player object OBJ1. Thus, movement of player object OBJ1 in accordance with a direction indication input through slide pad 15 is controlled in accordance with the orientation (the direction of line of sight) of player object OBJ1. In addition, a position of virtual camera 100 is set in accordance with a coordinate and an orientation (a direction of line of sight) of player object OBJ1. In the present example, a case where a coordinate P2 where virtual camera 100 is to be arranged is set in accordance with a coordinate V1 and the orientation (the direction of line of sight) of player object OBJ1 is shown.

It is noted that a direction of line of sight of player object OBJ1 is used as a direction parameter for controlling a reference direction of travel in a case where player object OBJ1 hits ball object OBJ4. By way of example, when there is no direction indication input through slide pad 15 in a case where player object OBJ1 hits ball object OBJ4, movement of ball object OBJ4 is controlled with a direction of line of sight of player object OBJ1 serving as a direction parameter. Namely, ball object OBJ4 moves in the direction of line of sight of player object OBJ1.

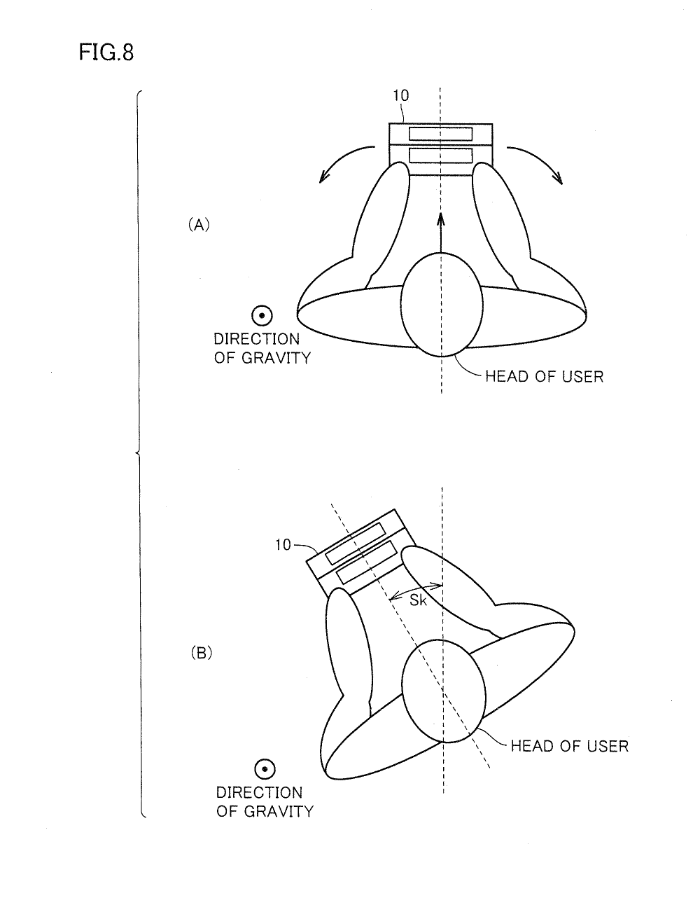

Referring to FIG. 8, in the present example, a case where a manner of operation of game device 10 in which game device 10 is rotated around a reference axis, with the direction of gravity being defined as the reference axis, is executed, is described.

Referring to FIG. 8(A), a case refers to a case where the user lifts his/her hand holding game device 10 to incline game device 10, and it is assumed that the first user viewpoint mode or the second user viewpoint mode has been set. It is noted that a direction perpendicular to the sheet surface is assumed as the direction of gravity in the present example.

Referring to FIG. 8(B), here, a case where game device 10 is rotated around a reference axis with the direction of gravity being defined as the reference axis is shown. Specifically, a case where rotation by an angle of rotation Sk to the left from the state in FIG. 8(A) has been made is shown. It is noted that an angle of rotation is detected by angular velocity sensor 40 in the present example, as described above.

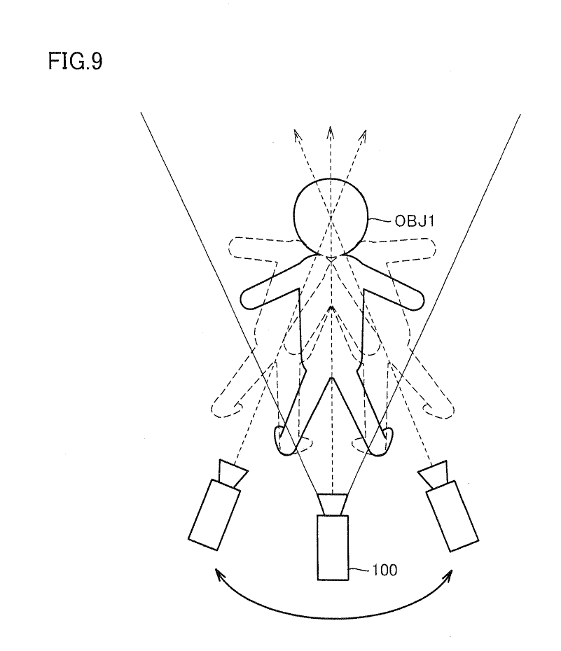

Referring to FIG. 9, in the present example, in the first or second user viewpoint mode, an orientation (a direction of line of sight) of player object OBJ1 is controlled in accordance with a detected angle of rotation.

Specifically, by way of example, when rotation by angle of rotation Sk to the left is made, for example, player object OBJ1 is rotated accordingly by angle of rotation Sk to the left. As the orientation of the player object varies, virtual camera 100 also similarly rotates.

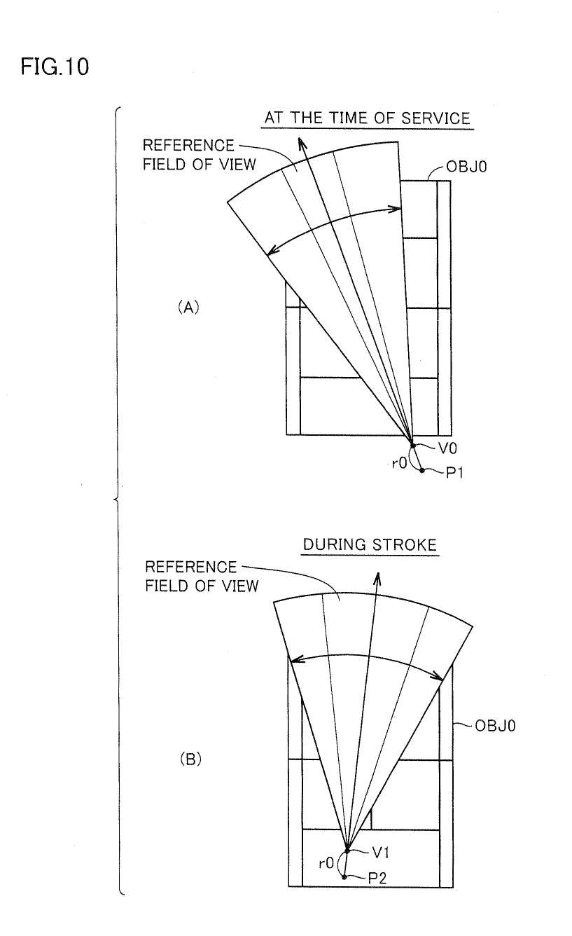

Referring to FIG. 10(A), a case where, at the time of service, a reference field of view is set from a position of player object OBJ1 by using a reference line and a direction of a center in an angle of the reference field of view is set as the orientation (the direction of line of sight) of player object OBJ1 is shown. Then, in the present example, in a case where game device 10 is rotated around a reference axis with the direction of gravity being defined as the reference axis, a range in which the orientation (the direction of line of sight) of player object OBJ1 moves along with rotation is shown. It is assumed that a range in which the orientation (the direction of line of sight) of player object OBJ1 can be varied at the time of service is determined in advance to a prescribed angle, with an initial direction of line of sight being defined as the reference.

Referring to FIG. 10(B), here, a case where, during stroke, a reference field of view is set from a position of player object OBJ1 by using a reference line and a direction of a center in an angle of the reference field of view is set as the orientation (the direction of line of sight) of player object OBJ1 is shown. Then, in the present example, in a case where game device 10 is rotated around a reference axis with the direction of gravity being defined as the reference axis, a range in which the orientation (the direction of line of sight) of player object OBJ1 moves along with rotation is shown. It is assumed that a range in which the orientation (the direction of line of sight) of player object OBJ1 can be varied during stroke is determined in advance to a prescribed angle, with an initial direction of line of sight being defined as the reference.

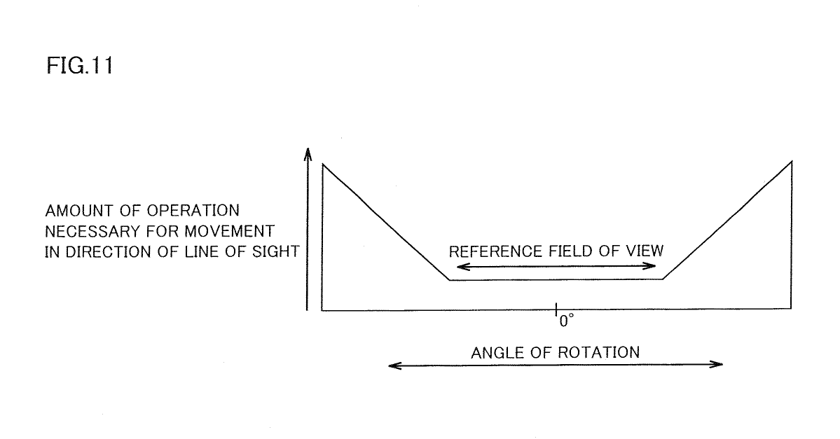

Referring to FIG. 11, in the present example, a case where an amount of operation is different between the reference field of view and a region other than the reference field of view is shown.

Specifically, in a case where an orientation (a direction of line of sight) of player object OBJ1 is varied in the reference field of view, it is assumed that an angle of rotation detected when game device 10 is rotated around the direction of gravity and an angle of rotation by which the orientation (the direction of line of sight) of player object OBJ1 is varied from a centerline have the same value.

On the other hand, a case where, in varying the orientation (the direction of line of sight) of player object OBJ1 in the region outside the reference field of view, an amount of operation thereof becomes greater as a distance from the reference field of view is greater, is shown.

Specifically, in a case of such movement that the orientation (the direction of line of sight) of player object OBJ1 is in a direction away from the reference field of view, prescribed weighting is made such that an amount of rotation by which game device 10 is rotated around the direction of gravity is greater. As a result of this processing, in the reference field of view, by varying the orientation (the direction of line of sight) of player object OBJ1 in coordination with an angle of rotation of game device 10, operability in game processing is improved, and in the outside of the reference field of view, by weighting the amount of operation for rotating game device 10, the direction of line of sight is prevented from easily being oriented toward the outside of the reference field of view, so that operability in game processing is improved. In a case where the orientation (the direction of line of sight) of player object OBJ1 is in the region outside the reference field of view, movement of player object OBJ1 (change in orientation) may be controlled such that the orientation (the direction of line of sight) of player object OBJ1 is gradually accommodated in the reference field of view.

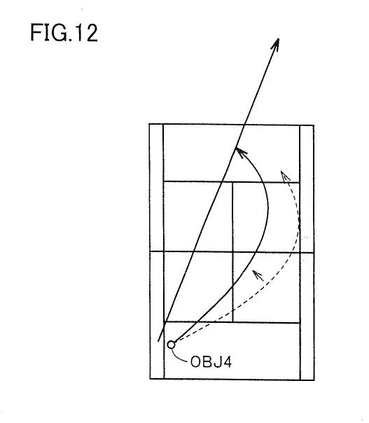

Referring to FIG. 12, here, an orientation (a direction of line of sight) of the player object is shown. When ball object OBJ4 is hit (button 14B is selected) without a direction indication input or the like through slide pad 15, the direction of line of sight is used as a direction parameter for controlling a reference direction of travel of the ball object when ball object OBJ4 is hit. Then, ball object OBJ4 is controlled to move to a position in accordance with the orientation (the direction of line of sight) of the player object in accordance with a movement parameter including the direction parameter, based on a prescribed algorithm for controlling movement of the ball object.

It is noted that the movement parameter can include other various parameters such as an initial hitting angle in connection with control of movement of the ball object and various parameters may be adjusted (corrected) in such a manner that simulation in accordance with that algorithm for controlling movement is carried out first to achieve movement to a target position.

On the other hand, when ball object OBJ4 is hit (button 14B is selected) together with a direction indication input or the like through slide pad 15, the movement parameter (the direction parameter) is corrected and control is carried out such that movement in a direction displaced from the reference direction of travel of the ball object is made. In the present example, for example, when right is input as a direction indication input through slide pad 15, the movement parameter (the direction parameter) of ball object OBJ4 is corrected and it is controlled to move to the right from the reference direction of travel of the ball object. It is noted that the direction of travel of the ball object may vary from the reference direction of travel in accordance with variation in the orientation (the direction of line of sight) of the player object.

Here, it is assumed that, with regard to control of movement of ball object OBJ4, in the user viewpoint mode, an input of an angle of rotation around a reference axis with the direction of gravity of game device 10 being defined as the reference axis is also accepted together with a direction indication input through slide pad 15.

Namely, in the user viewpoint mode, even when no direction indication input through slide pad 15 is provided, for example in a case where game device 10 is rotated to the right with the direction of gravity being defined as the reference axis (the angle of rotation being positive), it is determined that right has been input as the direction indication input, an amount of correction of the movement parameter (the direction parameter) is reflected in accordance with the angle of rotation, and control is carried out such that movement to the right from the reference direction of travel of the ball object is made.

As a result of such processing, a manner of operation of game device 10 is accepted as a prescribed input and reflected on the game processing. Thus, zest of the game increases.

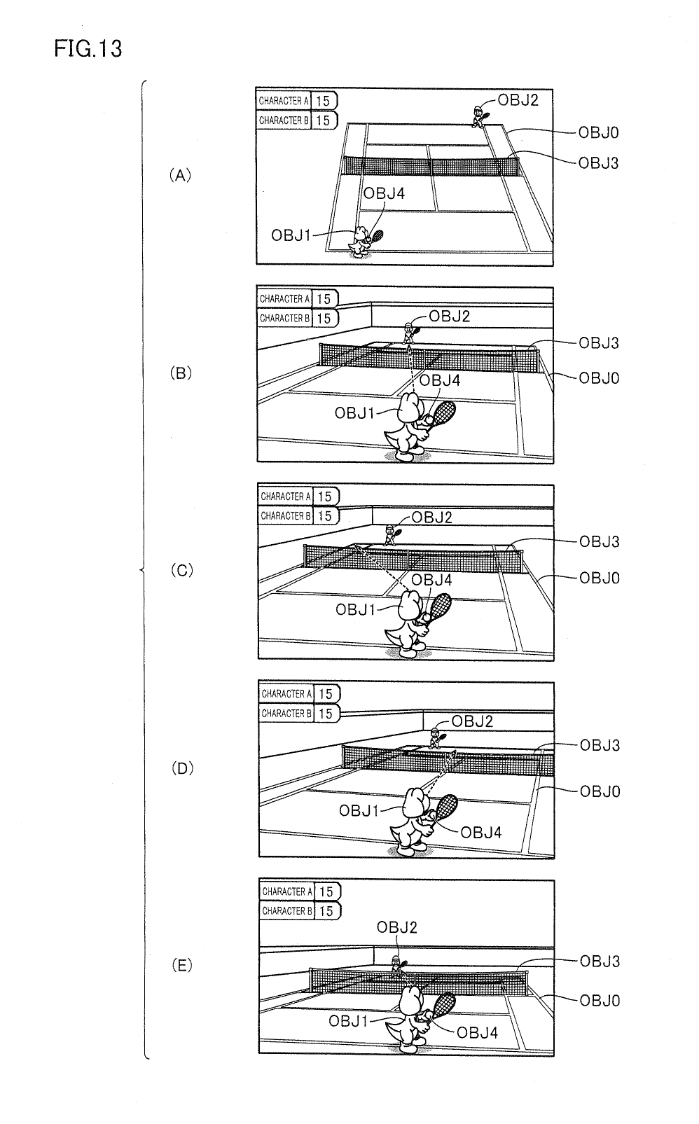

Referring to FIG. 13, it is assumed that a game image is displayed on upper LCD 22 of game device 10.

Referring to FIG. 13(A), here, a game image in the overhead viewpoint mode in accordance with an operation position in a case where a user's hand holding game device 10 is in parallel to the horizontal plane having the direction of gravity as the perpendicular is shown. Here, objects OBJ0 to OBJ4 are displayed and a game image at the time of service is displayed. In the case of the overhead viewpoint mode, as described above, it is assumed that a stereoscopic image in accordance with the two virtual cameras arranged in the virtual space in a fixed manner is displayed.

Referring to FIG. 13(B), here, a game image in the first user viewpoint mode in accordance with an operation position in a case where the user lifts his/her hand holding game device 10 to incline game device 10 is shown. Here, objects OBJ0 to OBJ4 are displayed and a game image at the time of service is displayed. In the case of the first user viewpoint mode, as described above, it is assumed that a two-dimensional image in accordance with a single virtual camera arranged in the virtual space is displayed.

In the present example, a case where player object OBJ1 is arranged at an initial position at the time of service, an orientation (a direction of line of sight) of player object OBJ1 is set based on that position, and the player object faces the direction of opposition object OBJ2 as an initial direction of line of sight is shown.

Referring to FIG. 13(C), here, in the first user viewpoint mode, a game image in a manner of operation in a case where game device 10 is rotated around the direction of gravity is shown. Here, objects OBJ0 to OBJ4 are displayed and a game image at the time of service is displayed. In the present example, a case where game device 10 is rotated toward the left and the direction of line of sight of player object OBJ1 accordingly moves to the left of opposition object OBJ2 is shown.

Referring to FIG. 13(D), here, in the first user viewpoint mode, a game image in another manner of operation in which game device 10 is rotated around the direction of gravity is shown. Here, objects OBJ0 to OBJ4 are displayed and a game image at the time of service is displayed. In the present example, a case where game device 10 is rotated toward the right and the direction of line of sight of player object OBJ1 accordingly moves to the right of opposition object OBJ2 is shown.

Referring to FIG. 13(E), here, a game image in the second user viewpoint mode in accordance with an operation position in a case where the user lifts his/her hand holding game device 10 to incline game device 10 at an angle close to vertical in the horizontal plane is shown. Here, objects OBJ0 to OBJ4 are displayed and a game image at the time of service is displayed. It is noted that, in the case of the second user viewpoint mode, it is assumed that a two-dimensional image in accordance with one virtual camera arranged in the virtual space as described above is displayed. In the present example, a case where player object OBJ1 is arranged at an initial position at the time of service, an orientation (a direction of line of sight) of player object OBJ1 is set based on that position, and the player object faces the direction of opposition object OBJ2 as an initial direction of line of sight is shown. Namely, the orientation of player object OBJ1 is the same as in FIG. 13(B), however, the position of virtual camera 100 is different. Specifically, a case where, in the first user viewpoint mode, shooting with virtual camera 100 is carried out from a position at angle of elevation w° in the horizontal direction, whereas in the second user viewpoint mode, shooting is carried out by positioning virtual camera 100 at angle of elevation 0°, and thus shooting at a height in the vicinity of eyes of player object OBJ1 is carried out is shown.

By way of example, in the game processing, a position of virtual camera 100 is changed in accordance with the operation position of operated game device 10. Specifically, when an angle in the direction of the z axis of game device 10 (angle of inclination θ) with the direction of gravity of game device 10 being defined as a reference direction is in a first range, a virtual camera position in accordance with the overhead viewpoint mode is set, and when it is in a second range, switching to a virtual camera position in accordance with the user viewpoint mode is made. Namely, switching between the viewpoint modes can be made in accordance with an operation position so as to change game processing. Thus, zest of a game can be increased. In addition, since switching between the viewpoint modes can be made in accordance with the operation position, an operation of a button or the like for switching between the viewpoint mode is not necessary and setting of a desired viewpoint mode can readily be made. Thus, operability is also good.

In addition, in the game device, a manner of operation of operated game device 10 is reflected on the game processing. Specifically, a direction of line of sight of the player object (that is, a direction of shooting of the virtual camera) is moved in accordance with an angle of rotation with the direction of gravity of game device 10 being defined as the reference axis. Since the direction of line of sight (the direction of shooting of the virtual camera) changes in coordination with motion of game device 10 as a result of such processing, operability of the game is improved and zest increases.

Moreover, an angle of rotation with the direction of gravity of game device 10 being defined as the reference axis is accepted as a direction indication input and it is reflected on control of movement of the ball object. As a result of this processing, a manner of operation of game device 10 is accepted as a prescribed input and game processing in coordination with motion of the game device is performed. Thus, zest increases.

[Data Stored in Main Memory]

Before description of a specific operation of CPU 311 of game device 10, data stored in main memory 32 as CPU 311 executes a game program will now be described.

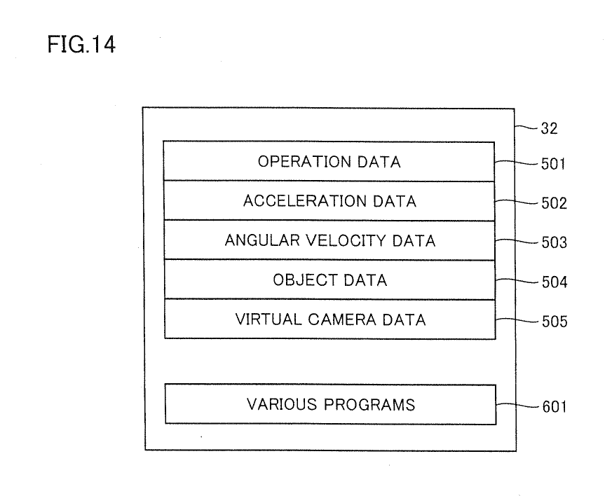

Referring to FIG. 14, main memory 32 stores operation data 501, acceleration data 502, angular velocity data 503, object data 504, virtual camera data 505, and various programs 601.

As described above, operation data 501 is data obtained by CPU 311 from operation button 14 and slide pad 15 once in a prescribed period of time (for example, once in a processing unit time period above) and then stored.

Acceleration data 502 is data indicating acceleration along directions of xyz axes obtained from acceleration sensor 39 every processing unit time above. Acceleration data 502 is obtained from acceleration sensor 39 every processing unit time above and stored in main memory 32. In the present example, an angle of inclination (a position) by which game device 10 is inclined in the direction of gravity is sensed based on the data indicating acceleration along the directions of xyz axes.

Angular velocity data 503 is data indicating a velocity of an angle of rotation around each of xyz axes obtained from angular velocity sensor 40 every processing unit time above. Angular velocity data 503 is obtained from angular velocity sensor 40 every processing unit time above and stored in main memory 32. It is assumed that angular velocity sensor 40 according to the present embodiment senses an angular velocity with each of xyz axes being defined as the center and rotation clockwise being defined as positive and rotation counterclockwise being defined as negative. In the present example, an angular velocity produced around the direction of gravity is calculated based on data indicating a velocity of an angle of rotation around each of xyz axes, and an angle of rotation (motion), that is, how much rotation was made in the reference, is sensed based on the angular velocity.

Object data 504 is data on tennis court object OBJ0, net object OBJ3, player object OBJ1, opposition object OBJ2, and ball object OBJ4. Specifically, it is data indicating a shape, a position, an orientation, and the like of each object. The object data is assumed as data set in advance at an initial value. Then, a value of the data is updated every processing unit time in accordance with object movement control.

Virtual camera data 505 is data indicating the number and arrangement of virtual cameras in accordance with the overhead viewpoint mode or the user viewpoint mode, and it includes data on those position and direction of shooting. As described above, for example, in the user viewpoint mode, a value of data on a position and a direction of shooting of the virtual camera is updated every processing unit time, in accordance with object movement control.

Various programs 601 are a variety of programs executed by CPU 311. For example, a game program or the like described above is stored in main memory 32 as various programs 601. In addition, an algorithm for controlling movement of the ball object, or the player object, or the opposition object, or the like in accordance with a manner of operation of the game device, a control algorithm relating to a direction of line of sight of the player object and arrangement setting of a virtual camera, and the like are also included in game programs to be stored in main memory 32.

[Game Processing]

A specific operation of CPU 311 of game device 10 in the present embodiment will now be described. Initially, when power of game device 10 is turned on, a boot program (not shown) is executed by CPU 311, and then a game program stored in internal memory for data saving 35 is thus read and stored in main memory 32. Then, as the game program stored in main memory 32 is executed by CPU 311, processing shown in the flowchart below is performed.

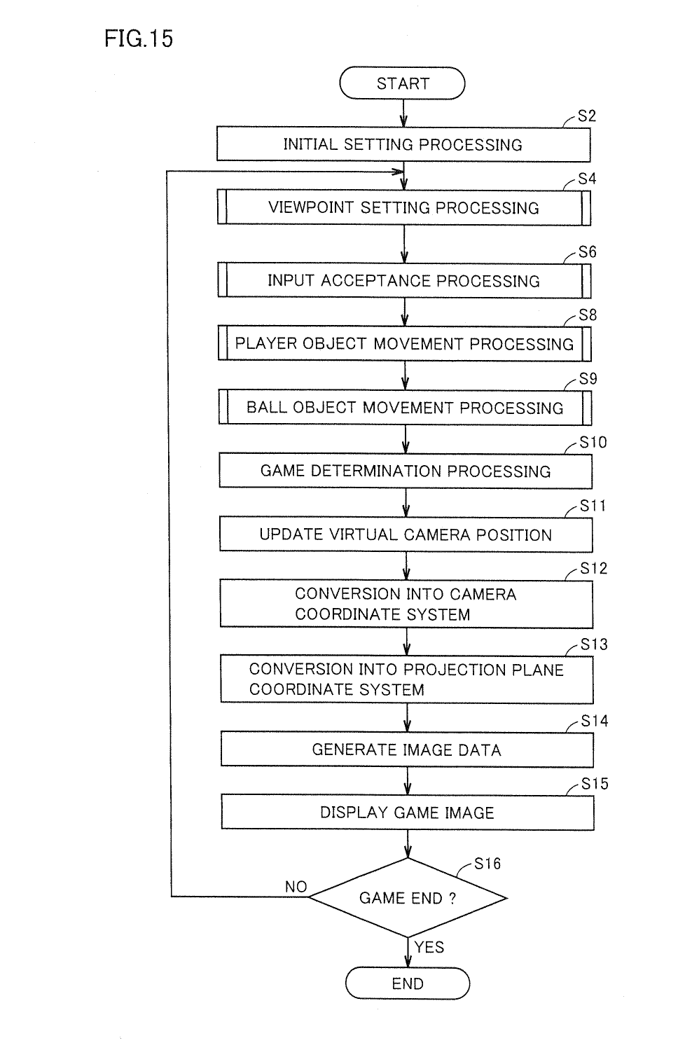

Referring to FIG. 15, as the game processing is started, CPU 311 initially performs initial setting processing (step S2). Specifically, reset processing is performed based on data set as an initial value in main memory 32, and each object is arranged at an initial coordinate in the three-dimensional world coordinate system which is a game space (a virtual space) as shown in FIG. 3 based on various types of data. For example, player object OBJ1 is arranged at initial coordinate V in the world coordinate system. In addition, virtual camera 100 is arranged at initial coordinate P in the world coordinate system.

Then, CPU 311 performs viewpoint setting processing in accordance with a position of game device 10 (step S4). Details of the viewpoint setting processing will be described later.

Then, CPU 311 performs input acceptance processing (step S6). Specifically, processing for accepting input from operation button 14 or slide pad 15 and processing for accepting input from angular velocity sensor 40 are performed. Details of the input acceptance processing will also be described later.

Then, CPU 311 performs player object movement processing (step S8). The player object movement processing is performed based on a prescribed movement control algorithm and on data accepted in the input acceptance processing. Details of the object movement processing will also be described later.

Then, CPU 311 performs ball object movement processing (step S9). The ball object movement processing is performed based on a prescribed movement control algorithm and on data accepted in the input acceptance processing. Details of the object movement processing will also be described later.

Then, CPU 311 performs game determination processing (step S10). For example, game winning and losing determination or the like based on tennis rules is made based on a position of ball object OBJ4 in tennis court object OBJ0.

Then, CPU 311 updates a position of the virtual camera (step S11). Specifically, the position of the virtual camera is updated in accordance with switching between the viewpoint modes or movement of the player object updated in accordance with the object movement processing.

Then, CPU 311 converts the position of the player object or the like into a three-dimensional camera coordinate system with a position of the arranged virtual camera being defined as the reference (step S12).

Then, CPU 311 converts the resultant three-dimensional camera coordinate system into a two-dimensional projection plane coordinate system (step S13). It is noted that designation of a texture, clipping (cutting of an invisible world), or the like is also carried out here. Thus, two-dimensional image data obtained by shooting the player object or the like with the virtual camera can be obtained.

Then, CPU 311 performs processing for generating image data serving as a game image (step S14).

Then, CPU 311 outputs the image data to upper LCD 22 for display of the game image (step S15). It is noted that, in the case of the user viewpoint mode, a two-dimensional image is displayed. Alternatively, in the case of the overhead viewpoint mode, a stereoscopic image is displayed.

Then, whether the game has ended or not is determined (step S16). When it is determined that the game has not ended (NO in step S16), the process again returns to step S4. It is noted that the processing above is repeated every processing unit time.

On the other hand, when the game has ended (YES in step S16), the process ends (end).

The viewpoint setting processing will now be described.

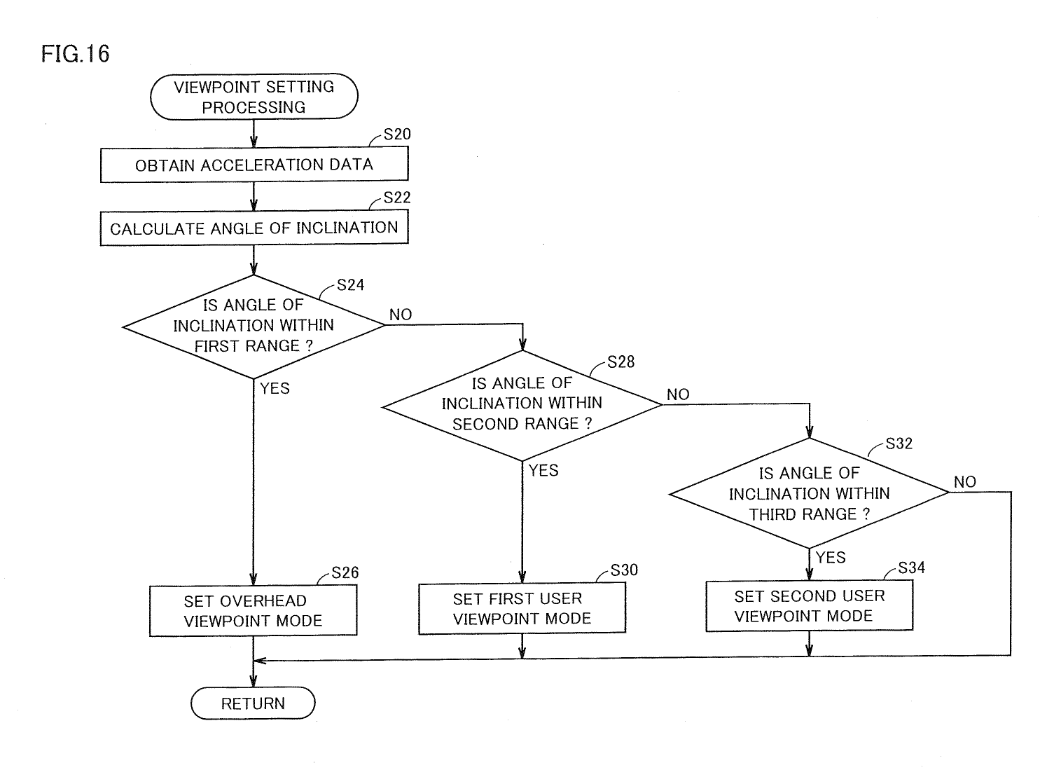

Referring to FIG. 16, initially, acceleration data is obtained (step S20).

Specifically, CPU 311 obtains acceleration data along directions of xyz axes from acceleration sensor 39.

Then, CPU 311 calculates an angle of inclination by which the direction of the z axis of game device 10 is inclined in the direction of gravity (step S22).

Then, CPU 311 determines whether the angle of inclination is within the first range or not (step S24). For example, as described with reference to FIG. 5, whether angle of inclination θ is smaller than the first prescribed angle (S°) or not (within the range of −180°≦θ<S°) is determined.

When CPU 311 determines that the angle of inclination is within the first range (YES in step S24), it sets the overhead viewpoint mode (step S26). Then, the process ends (return).

On the other hand, when CPU 311 determines in step S24 that the angle of inclination is not within the first range (NO in step S24), it determines whether the angle of inclination is within the second range or not (step S28). For example, as described with reference to FIG. 5, whether or not angle of inclination θ is equal to or greater than the first prescribed angle (S°) and smaller than the second prescribed angle (within the range of S≦θ<T°) is determined.

When CPU 311 determines that the angle of inclination is within the second range (YES in step S28), it sets the first user viewpoint mode (step S30). Then, the process ends (return).

On the other hand, when CPU 311 determines in step S28 that the angle of inclination is not within the second range (NO in step S28), it determines whether the angle of inclination is within a third range or not (step S32). For example, as described with reference to FIG. 5, whether or not angle of inclination θ is equal to or greater than the second prescribed angle (S°) (within the range of T°≦θ<180°) is determined.

When CPU 311 determines that the angle of inclination is within the third range (YES in step S32), it sets the second user viewpoint mode (step S34). Then, the process ends (return).

When the angle of inclination is included in none of the ranges (NO in step S32), the angle of inclination is processed as invalid (return).

As a result of such processing, the viewpoint mode of the virtual camera is set in accordance with the operation position of game device 10.

The input acceptance processing will now be described.

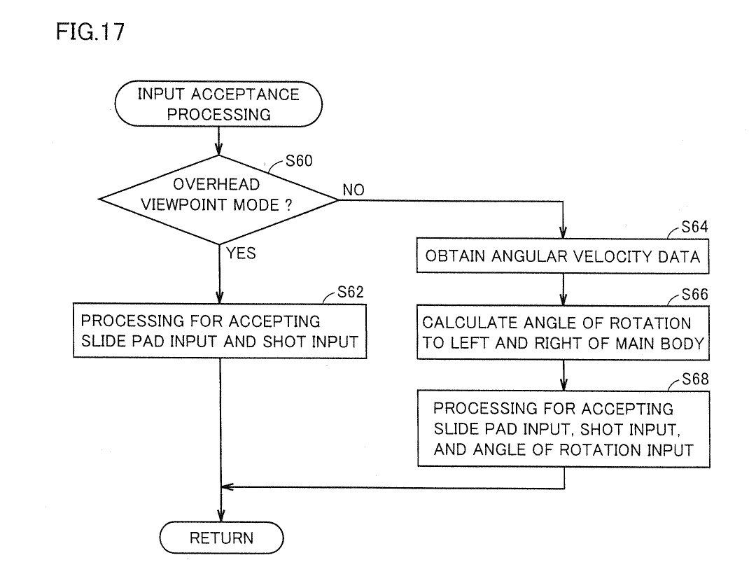

Referring to FIG. 17, initially, CPU 311 determines whether the overhead viewpoint mode has been set or not (step S60). Specifically, CPU 311 determines which viewpoint mode has been set based on the viewpoint setting processing.

Then, when CPU 311 determines in step S60 that the overhead viewpoint mode has been set (YES in step S60), it performs processing for accepting a slide pad input and a shot input (step S62). Then, the process ends (return). It is assumed in the present example that the shot input refers to selection of button 14B among operation buttons 14.

On the other hand, when CPU 311 determines in step S60 that the overhead viewpoint mode has not been set (NO in step S60), that is, when the user viewpoint mode has been set, it obtains angular velocity data (step S64).

Then, CPU 311 calculates an angle of rotation to the left and right of a main body based on the angular velocity data (step S66). Specifically, an angle of rotation around the reference axis with the direction of gravity being defined as the reference axis is calculated. A direction of rotation can be determined based on a positive or negative sign of the angle of rotation.

Then, CPU 311 performs processing for accepting a slide pad input, a shot input, and an angle of rotation input. Then, the process ends (return).

Namely, in the case of the overhead viewpoint mode, only a slide pad input and a shot input are considered as active, while in the user viewpoint mode, a slide pad input and a shot input as well as an angle of rotation to the left and right in game device are also considered as valid as inputs.

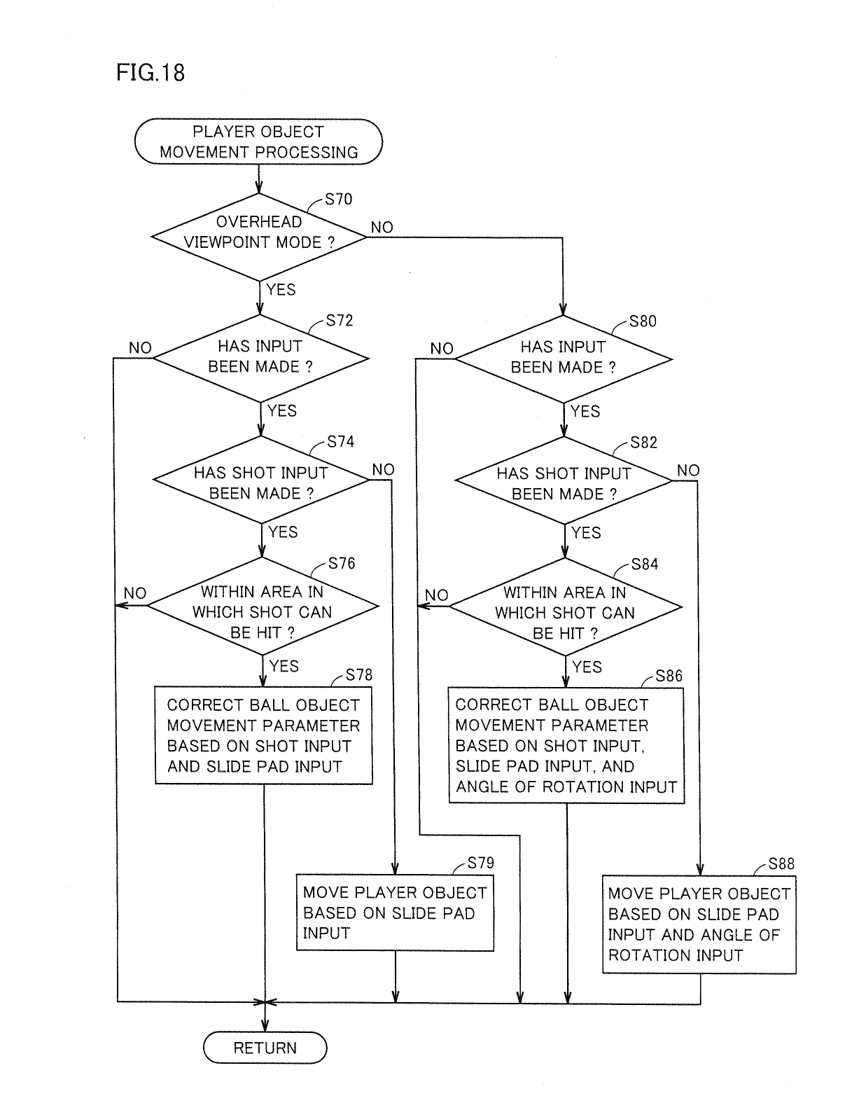

Referring to FIG. 18, initially, CPU 311 determines whether the overhead viewpoint mode has been set or not (step S70). Specifically, CPU 311 determines which viewpoint mode has been set based on the viewpoint setting processing.

Then, when CPU 311 determines in step S70 that the overhead viewpoint mode has been set (YES in step S70), it determines whether an input in accordance with the input acceptance processing has been made or not (step S72).

When CPU 311 determines in step S72 that an input has been made (YES in step S72), it determines whether a shot input has been made or not (step S74). Specifically, whether an input indication through button 14B for hitting ball object OBJ4 has been given or not is determined. Such determination can be made based on operation data 501 in main memory 32.

When it is determined in step S74 that a shot input has been made (YES in step S74), whether or not ball object OBJ4 is present in an area in which player object OBJ1 can hit a shot is determined (step S76). Specifically, it is assumed that an area in which ball object OBJ4 can be hit is set in advance within a prescribed range, based on a position of player object OBJ1. Determination processing as to whether ball object OBJ4 is present in that range or not is performed.

When CPU 311 determines in step S76 that ball object OBJ4 is present in the area in which player object OBJ1 can hit a shot (YES in step S76), it corrects a ball object movement parameter based on a shot input and a slide pad input (step S78). Specifically, the movement parameter (the direction parameter) for controlling the direction of travel of the ball object to the direction of line of sight of player object OBJ1 in accordance with the shot input is corrected. In addition, when a slide pad input has been made, the movement parameter (the direction parameter) is further corrected in accordance with the direction input indication. It is noted that other movement parameters, for example, such parameters as used for controlling movement of the ball object including a ball hitting angle and spin, may be corrected, without limited to the direction parameter.

Then, the process ends (return).

On the other hand, when CPU 311 determines that ball object OBJ4 is not present in the area in which player object OBJ1 can hit a shot (NO in step S76), the process ends (return). In this case, since a shot cannot be hit, for example a trajectory of ball object OBJ4 does not change and such animation as player object OBJ1 with a racket making an air shot can be provided.

Namely, when a shot input has been made, a slide pad input is used for controlling movement of ball object OBJ4 and not used for controlling movement of player object OBJ1. It is noted that, at the time of a shot input as well, a slide pad input may be reflected on control of movement of player object OBJ1, with a degree of reflection being lowered.

On the other hand, when CPU 311 determines in step S74 that a shot input has not been made (NO in step S74), it controls movement in accordance with a prescribed algorithm for controlling movement of player object OBJ1 based on a slide pad input (step S79). Specifically, a direction of movement and an amount of movement are determined in accordance with a direction input indication through the slide pad and player object OBJ1 moves. It is noted that setting of an orientation (a direction of line of sight) of the player object is controlled as will be described later.

Then, the process ends (return).

When CPU 311 determines in step S70 that the overhead viewpoint mode has not been set (NO in step S70), that is, when the user viewpoint mode has been set, it determines whether an input in accordance with the input acceptance processing has been made or not (step S80).

When CPU 311 determines in step S80 that an input has been made (YES in step S80), it determines whether a shot input has been made or not (step S82). Specifically, whether an input indication through button 14B for hitting ball object OBJ4 has been made or not is determined. Such determination can be made based on operation data 501 in main memory 32.

When it is determined in step S82 that a shot input has been made (YES in step S82), whether or not ball object OBJ4 is present in an area in which player object OBJ1 can hit a shot is determined (step S84). Specifically, it is assumed that an area in which ball object OBJ4 can be hit is set in advance within a prescribed range, based on a position of player object OBJ1. Determination processing as to whether ball object OBJ4 is present in that range or not is performed.

When CPU 311 determines in step S84 that ball object OBJ4 is present in the area in which player object OBJ1 can hit a shot (YES in step S84), it corrects a ball object movement parameter based on a shot input, a slide pad input, and an angle of rotation input (step S86). Specifically, the movement parameter (the direction parameter) for controlling the direction of travel of the ball object to the direction of line of sight of player object OBJ1 in accordance with the shot input is corrected. In addition, when a slide pad input has been made, the movement parameter (the direction parameter) is further corrected in accordance with the direction input indication. Moreover, the movement parameter (the direction parameter) is corrected also based on the angle of rotation input. For example, when game device 10 is rotated in the right direction (the angle of rotation being positive), it is determined that right has been input as the direction indication input and the movement parameter (the direction parameter) is corrected in accordance with the angle of rotation. It is noted that other movement parameters, for example, such parameters as used for controlling movement of the ball object including a ball hitting angle and spin, may be corrected, without limited to the direction parameter.

Though a case where, when a shot input has been made, a slide pad input and an angle of rotation input are reflected on correction of the ball object movement parameter has been described in the present example, such movement control as correcting also the movement parameter (the direction parameter) of player object OBJ1 to vary the orientation (the direction of line of sight) of the player object may be carried out. In that case, the direction of travel of the ball object should only be varied in conformity with variation in orientation (direction of line of sight) of the player object.

Then, the process ends (return).

On the other hand, when CPU 311 determines that ball object OBJ4 is not present in the area in which player object OBJ1 can hit a shot (NO in step S84), the process ends (return). In this case, since a shot cannot be hit, for example a trajectory of ball object OBJ4 does not change and such animation as player object OBJ1 with a racket making an air shot can be provided.

Namely, when a shot input has been made, a slide pad input is used for controlling movement of ball object OBJ4 and not used for controlling movement of player object OBJ1. It is noted that, at the time of a shot input as well, a slide pad input may be reflected on control of movement of player object OBJ1, with a degree of reflection being lowered.

On the other hand, when CPU 311 determines in step S82 that a shot input has not been made (NO in step S82), it controls movement in accordance with a prescribed algorithm for controlling movement of the player object based on a slide pad input and an angle of rotation input (step S88). Specifically, a direction of movement and an amount of movement are determined in accordance with a direction input indication through the slide pad and the player object moves. Moreover, the orientation (the direction of line of sight) of player object OBJ1 is further controlled based on the angle of rotation input. It is noted that, in the present embodiment, as described above, in the case where the overhead viewpoint mode has not been set in step S70, the angle of rotation input is reflected on the operation. In other embodiments, however, depending on contents of the game, to the contrary, such an operation method that switching is made to reflect the angle of rotation input on the operation only when the overhead viewpoint mode has been set may be employed.

It is noted that setting of an orientation (a direction of line of sight) of the player object is controlled as will be described later.

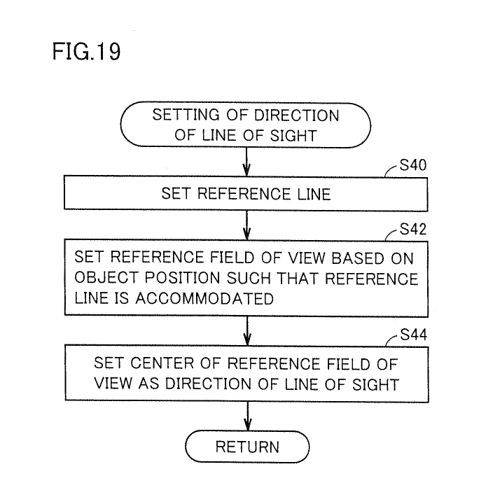

Referring to FIG. 19, initially, CPU 311 sets the reference line (step S40). Specifically, as described with reference to FIGS. 7(A) and 7(B), any of reference lines rf0 and rf1 and reference line rf2 is selected based on whether a game progress situation indicates the timing of service or during stroke and based on a position of the player object.

Then, CPU 311 sets the reference field of view based on the object position, so as to accommodate the reference line (step S42).

Then, CPU 311 sets the center of the reference field of view as the direction of line of sight (step S44).

Specifically, as described with reference to FIGS. 7(C) and 7(D), the direction of the center of the reference field of view is set as the orientation (the direction of line of sight) of the object.

Then, the process ends (return).

With the direction of line of sight being defined as the reference, processing for moving the ball object and arrangement of the virtual camera are determined.

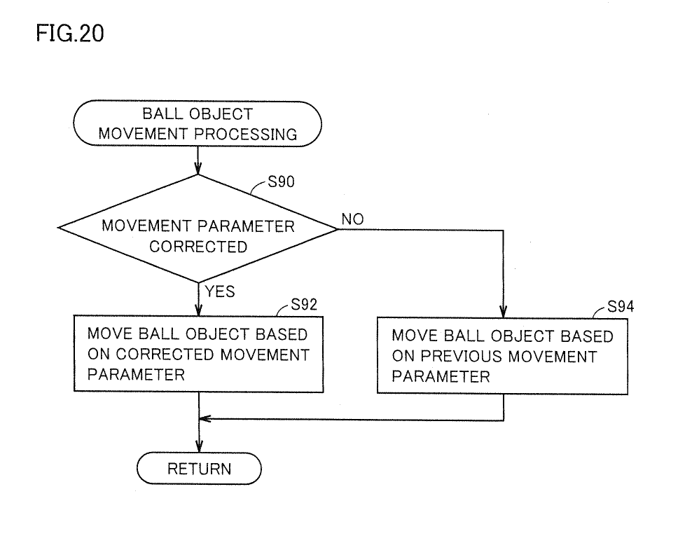

Referring to FIG. 20, CPU 311 determines whether the movement parameter has been corrected or not (step S90). Specifically, whether the movement parameter (the direction parameter) of the ball object has been corrected or not is determined based on a slide pad input or the like in accordance with the input acceptance processing.

Then, when CPU 311 determines in step S90 that the movement parameter has been corrected (YES in step S90), it controls movement of the ball object in accordance with a prescribed movement control algorithm based on the corrected movement parameter (step S92). For example, when ball object OBJ4 is hit by a racket of player object OBJ1, ball object OBJ4 is controlled to move in the direction of line of sight of player object OBJ1. In this case, in the case of the shot input, movement of the ball object is controlled to move in the direction of line of sight of player object OBJ1. On the other hand, in the case where a slide pad input or an angle of rotation input to the right has been made, movement of the ball object is controlled to move from the direction of line of sight to the right.

On the other hand, when CPU 311 determines in step S90 that the movement parameter has not been corrected (NO in step S90), movement of the ball object is controlled based on the previous movement parameter (step S94). When correction is not to be made, such movement control as maintaining the direction of travel of the ball object is carried out in accordance with the previously set movement parameter.

Then, the process ends (return).

(Variation)

A case where an angle of rotation input is reflected on ball object movement control when both of a shot input and an angle of rotation input have been made has been described above as the ball object movement processing, however, the timing of inputs does not have to be the same. For example, a period during which an angle of rotation input is accepted is provided for a prescribed period after a shot input was made, so that the angle of rotation input may be reflected on ball object movement control when the angle of rotation input is made during that period.

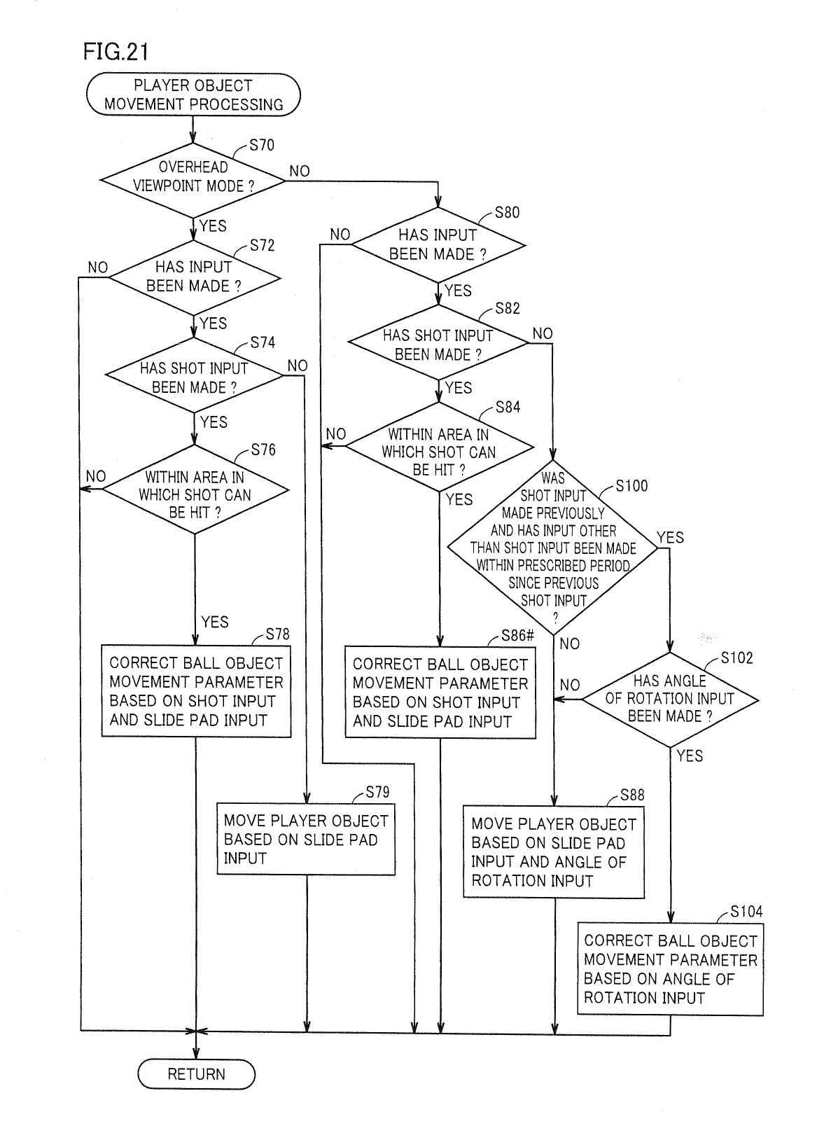

Referring to FIG. 21, as compared with the flowchart in FIG. 18, difference is found in change of step S86 to step S86# and in further providing step S100 to step S104. Since the flow is otherwise the same, detailed description thereof will not be repeated.

Specifically, when CPU 311 determines in step S84 that ball object OBJ4 is present in the area in which player object OBJ1 can hit a shot (YES in step S84), it corrects a ball object movement parameter based on a shot input and a slide pad input (step S86#). Specifically, the movement parameter (the direction parameter) for controlling the direction of travel of the ball object to the direction of line of sight of player object OBJ1 is corrected in accordance with the shot input. In addition, when a slide pad input has been made, the movement parameter (the direction parameter) is further corrected in accordance with the direction input indication.

Then, the process ends (return).

In addition, when CPU 311 determines in step S82 that a shot input has not been made (NO in step S82), it then determines whether or not a shot input was made previously and whether an input other than a shot input has been made within a prescribed period since the previous shot input when the shot input had been made previously (step S100). For example, for making determination as to whether an input has been made within the prescribed period, assuming a processing unit time in a period until an input other than the shot input is made after the shot input as one count, whether the number of counts is within a prescribed number of times may be determined.

When CPU 311 determines that a shot input was made previously and an input other than a shot input has been made within the prescribed period since the previous shot input when the shot input had been made previously (YES in step S100), it determines whether an input other than a shot input is an angle of rotation input or not (step S102).

When CPU 311 determines that an input other than a shot input is the angle of rotation input (YES in step S102), it corrects a ball object movement parameter based on the angle of rotation input (step S104). Specifically, the movement parameter (the direction parameter) is corrected based on the angle of rotation input. For example, when game device 10 is rotated in the right direction (the angle of rotation being positive), it is determined that right has been input as the direction indication input and the movement parameter (the direction parameter) is corrected in accordance with the angle of rotation. It is noted that such other parameters as used for controlling movement of the ball object may be corrected without limited to the direction parameter.

Though a case where, when a shot input has been made, an angle of rotation input is reflected on correction of a ball object movement parameter has been described in the present example, such movement control as correcting also the movement parameter (the direction parameter) of player object OBJ1 to vary an orientation (a direction of line of sight) of the player object may be carried out. In that case, the direction of travel of the ball object should only be varied in conformity with variation in orientation (direction of line of sight) of the player object.

Then, the process ends (return).

On the other hand, when CPU 311 determines that a shot input was not made previously or an input other than a shot input has not been made within the prescribed period since the previous shot input when the shot input had been made previously (NO in step S100), it controls movement in accordance with a prescribed algorithm for controlling movement of the player object based on a slide pad input and an angle of rotation input (step S88). Further, when it is determined in step S102 that an input other than a shot input is not an angle of rotation input (NO in step S102), movement is controlled in accordance with a prescribed algorithm for controlling movement of the player object based on a slide pad input and an angle of rotation input (step S88). Specifically, a direction of movement and an amount of movement are determined in accordance with a direction input indication through the slide pad and the player object moves. Moreover, the orientation (the direction of line of sight) of player object OBJ1 is further controlled based on the angle of rotation input.

As a result of this processing, for example, when the angle of rotation input has been made as an input other than a shot input during the prescribed period after the shot input was made, the movement parameter is corrected in accordance with the angle of rotation input and the angle of rotation input can be reflected on ball object movement control.

In addition, though a case of application to portable game device 10 has been described above, the case is not limited to the portable game device. For example, application to a stationary game device, a portable telephone, a personal handyphone system (PHS), and such a portable information terminal as a PDA is also possible. Moreover, application to a stationary game machine and a personal computer is also possible. A specific example will be described below.

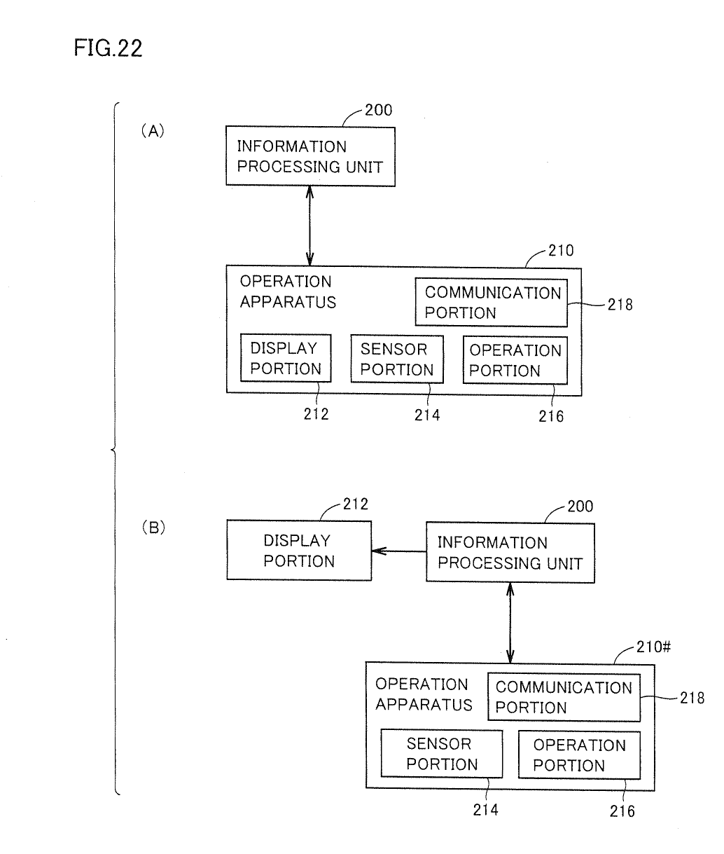

Referring to FIG. 22(A), here, a game system constituted of an information processing unit 200 and an operation apparatus 210 is shown. A function of information processing unit 31 may be performed, for example, in information processing unit 200 within a main body apparatus (not shown) provided separately from operation apparatus 210. In that case, operation apparatus 210 provided separately from the main body apparatus may be provided with a display portion 212 including lower LCD 12 or upper LCD 22, a sensor portion 214 including acceleration sensor 39 and angular velocity sensor 40, an operation portion 216 including operation button 14 and slide pad 15, and a communication portion 218 including wireless communication module 36 and the like. Then, by transmitting and receiving data to and from information processing unit 200 of the main body apparatus through communication portion 218, game processing the same as described above can be performed. Specifically, data from sensor portion 214 and operation portion 216 is transmitted through communication portion 218, prescribed game processing is performed in information operation unit 200, and thereafter communication portion 218 receives image data generated by information processing unit 200 so that a game image is displayed on display portion 212.

Referring to FIG. 22(B), here, a game system constituted of information processing unit 200, display portion 212, and an operation apparatus 210# is shown. As compared with FIG. 22(A), difference is found in that display portion 212 is not provided in the operation apparatus. Namely, for example, the display portion can be provided as an external apparatus (such as a monitor) and the external apparatus can also be caused to display a game image. Specifically, data from sensor portion 214 and operation portion 216 is transmitted through communication portion 218, prescribed game processing is performed in information operation unit 200, and thereafter image data generated by information processing unit 200 is output to display portion 212 which is the external apparatus, so that a game image is displayed.

<Other Forms>

Though game device 10 has been exemplified as a representative example of an information processing apparatus in the embodiment described above, the information processing apparatus is not limited thereto. Namely, an application executable by a personal computer may be provided as a program. Here, the program may be incorporated as a partial function of various applications executed on the personal computer.

In addition, though a case where a tennis game is played has been described as game processing in the present example, the game processing is not limited to the tennis game and it is applicable also to other games. For example, game processing may be performed also in a golf game as a viewpoint mode is switched in accordance with an operation position of the game device. For example, switching between a top view of a course and a shot view may be made in accordance with a position of the game device. In the shot view, a direction of ball hitting may be controlled in accordance with a position of the game device, and in the top view, a direction of a shot may be operated in response to an operation of the slide pad or the touch panel. Here, in the top view, an icon or the like for operation may be displayed, while in the shot view, the number of function indicators such as an icon for improving the sense of realism may be decreased so that functional display may be varied in accordance with an operation method. Further, in the golf game as well, after a ball is hit, a manner of operation of the game device, such as motion of rotation or the like in the right direction, may be reflected on the game processing so that a parameter used for ball movement control may be changed.

While certain example systems, methods, devices, and apparatuses have been described herein, it is to be understood that the appended claims are not to be limited to the systems, methods, devices, and apparatuses disclosed, but on the contrary, are intended to cover various modifications and equivalent arrangements included within the spirit and scope of the appended claims.

What is claimed is:

1. A game system, comprising:
an operation apparatus; and
an information processing unit for transmitting and receiving data to and from said operation apparatus,
said operation apparatus including
a display portion for displaying information,
an operation portion for accepting a user's operation input, and
a sensor portion for obtaining position data in a space where said operation apparatus is present, and
said information processing unit including
a viewpoint mode switching unit for setting a first viewpoint mode for displaying on said display portion a display image picked up based on a position and a direction of image pick-up of a first virtual camera in a virtual space on a game when the position data of said operation apparatus obtained by said sensor portion is in a first range and setting a second viewpoint mode for displaying on said display portion a display image picked up based on a position and a direction of image pick-up of a second virtual camera when the position data of said operation apparatus is in a second range, and
a game processing unit for performing game processing in accordance with the operation input accepted by said operation portion.

2. The game system according to claim 1, wherein
said operation portion has a direction input portion for accepting at least an input of a direction, and
said game processing unit moves a first object provided in said virtual space in accordance with the input of the direction accepted by said direction input portion.

3. The game system according to claim 2, wherein
said game processing unit controls the position and the direction of image pick-up of said second virtual camera in accordance with the position data of said operation apparatus in said second viewpoint mode.

4. The game system according to claim 2, wherein
said game processing unit provides a second object of which movement in said virtual space is controlled, and
said game processing unit controls movement of said second object in accordance with the operation input accepted by said operation portion at prescribed timing in said first viewpoint mode and controls movement thereof in accordance with the position data of said operation apparatus at prescribed timing in said second viewpoint mode.

5. The game system according to claim 2, wherein
said game processing unit provides a second object of which movement in said virtual space is controlled, and
said game processing unit controls movement of said second object in accordance with the operation input accepted by said operation portion at prescribed timing in said first viewpoint mode, and controls movement thereof in accordance with the operation input accepted by said operation portion at prescribed timing and controls movement thereof in accordance with the position data of said operation apparatus at timing different from said prescribed timing in said second viewpoint mode.

6. The game system according to claim 1, wherein
in said virtual space, said first virtual camera is set at a position higher than positions of said first object and said second virtual camera.

7. The game system according to claim 1, wherein
a case where the position data of said operation apparatus is in said first range refers to a case where an orientation of a display surface of said display portion is close to horizontal, and a case where it is in said second range refers to a case where an orientation of the display surface of said display portion is close to vertical.

8. The game system according to claim 1, wherein
said sensor portion corresponds to an inertial sensor.

9. The game system according to claim 8, wherein
said inertial sensor includes an acceleration sensor and an angular velocity sensor.

10. The game system according to claim 1, wherein
said information processing unit is provided in a main body apparatus provided separately from said operation apparatus,
said operation apparatus further includes a communication portion for transmitting and receiving data to and from said main body apparatus,
said communication portion of said operation apparatus transmits the operation input accepted by said operation portion and the position data obtained by said sensor portion to said main body apparatus and receives game image data in accordance with the game processing performed by said information processing unit of said main body apparatus, and
said display portion of said operation apparatus displays a game image in accordance with the received game image data.

11. A game system, comprising:
an operation apparatus; and
an information processing unit for transmitting and receiving data to and from said operation apparatus,
said operation apparatus including
a display portion for displaying information,
an operation portion for accepting a user's operation input, and
a sensor portion for obtaining first position data of an axis of a first prescribed direction in a reference direction in a space where said operation apparatus is present and second position data around an axis of a second prescribed direction, and
said information processing unit performing game processing in accordance with the operation input accepted by said operation portion when the first position data of said operation apparatus obtained by said sensor portion is in a first range and performing game processing in accordance with the operation input accepted by said operation portion and the second position data of said operation apparatus obtained by said sensor portion when the first position data of said operation apparatus obtained by said sensor portion is in a second range.

12. A portable game device, comprising:
an operation apparatus; and
an information processing unit for transmitting and receiving data to and from said operation apparatus,
said operation apparatus including
a display portion for displaying information,
an operation portion for accepting a user's operation input, and
a sensor portion for obtaining position data in a space where said operation apparatus is present, and
said information processing unit including
a viewpoint mode switching unit for setting a first viewpoint mode for displaying on said display portion a display image picked up based on a position and a direction of image pick-up of a first virtual camera in a virtual space on a game when the position data of said operation apparatus obtained by said sensor portion is in a first range and setting a second viewpoint mode for displaying on said display portion a display image picked up based on a position and a direction of image pick-up of a second virtual camera when the position data of said operation apparatus is in a second range, and
a game processing unit for performing game processing in accordance with the operation input accepted by said operation portion.

13. A method of controlling an information processing unit operating in cooperation with an operation apparatus having a display portion for displaying information, comprising the steps of:
accepting a user's operation input;
obtaining position data in a space where said operation apparatus is present;
setting a first viewpoint mode for displaying on said display portion a display image picked up based on a position and a direction of image pick-up of a first virtual camera in a virtual space on a game when the obtained position data of said operation apparatus is in a first range and a second viewpoint mode for displaying on said display portion a display image picked up based on a position and a direction of image pick-up of a second virtual camera when the position data of said operation apparatus is in a second range; and
performing game processing in accordance with the accepted operation input.

14. The method of controlling an information processing unit according to claim 13, wherein
said step of accepting a user's operation input includes the step of accepting at least an input of a direction, and
in said step of performing game processing, a first object provided in said virtual space is moved in accordance with the accepted input of the direction.

15. The method of controlling an information processing unit according to claim 14, wherein
in said step of performing game processing, in said second viewpoint mode, the position and the direction of image pick-up of said second virtual camera are controlled in accordance with the position data of said operation apparatus.

16. The method of controlling an information processing unit according to claim 14, wherein
said step of performing game processing includes the steps of
providing a second object of which movement in said virtual space is controlled,
controlling movement of said second object in accordance with the operation input accepted at prescribed timing in said first viewpoint mode, and
controlling movement of said second object in accordance with the position data of said operation apparatus at prescribed timing in said second viewpoint mode.

17. The method of controlling an information processing unit according to claim 14, wherein
said step of performing game processing includes the steps of
providing a second object of which movement in said virtual space is controlled,
controlling movement of said second object in accordance with the operation input accepted at prescribed timing in said first viewpoint mode, and
controlling movement of said second object in accordance with the operation input accepted at prescribed timing and controlling movement thereof in accordance with the position data of said operation apparatus at timing different from said prescribed timing in said second viewpoint mode.

18. The method of controlling an information processing unit according to claim 13, wherein
in said virtual space, said first virtual camera is set at a position higher than positions of said first object and said second virtual camera.

19. The method of controlling an information processing unit according to claim 13, wherein
a case where the position data of said operation apparatus is in said first range refers to a case where an orientation of a display surface of said display portion is close to horizontal, and a case where it is in said second range refers to a case where an orientation of the display surface of said display portion is close to vertical.

20. A method of controlling an information processing unit operating in cooperation with an operation apparatus having a display portion for displaying information, comprising the steps of:
accepting a user's operation input;
obtaining first position data of an axis of a first prescribed direction in a reference direction in a space where said operation apparatus is present and second position data around an axis of a second prescribed direction; and
performing game processing in accordance with the accepted operation input when the obtained first position data of said operation apparatus is in a first range and performing game processing in accordance with the accepted operation input and the obtained second position data of said operation apparatus when the obtained first position data of said operation apparatus is in a second range.

21. A non-transitory storage medium encoded with a computer readable program for controlling an information processing unit and executable by a computer of the information processing unit, said information processing unit operating in cooperation with an operation apparatus having a display portion for displaying information, said program comprising:
instructions for accepting a user's operation input;
instructions for obtaining position data in a space where said operation apparatus is present;
instructions for setting a first viewpoint mode for displaying on said display portion a display image picked up based on a position and a direction of image pick-up of a first virtual camera in a virtual space on a game when the obtained position data of said operation apparatus is in a first range and setting a second viewpoint mode for displaying on said display portion a display image picked up based on a position and a direction of image pick-up of a second virtual camera when the position data of said operation apparatus is in a second range; and
instructions for performing game processing in accordance with the accepted operation input.

22. The non-transitory storage medium according to claim 21, wherein
said instructions for accepting a user's operation input include instructions for accepting at least an input of a direction, and
said instructions for performing game processing cause a first object provided in said virtual space to move in accordance with the accepted input of the direction.

23. The non-transitory storage medium according to claim 22, wherein
said instructions for performing game processing control the position and the direction of image pick-up of said second virtual camera in accordance with the position data of said operation apparatus in said second viewpoint mode.

24. The non-transitory storage medium according to claim 22, wherein
said instructions for performing game processing include
instructions for providing a second object of which movement in said virtual space is controlled,
instructions for controlling movement of said second object in accordance with the operation input accepted at prescribed timing in said first viewpoint mode, and
instructions for controlling movement of said second object in accordance with the position data of said operation apparatus at prescribed timing in said second viewpoint mode.

25. The non-transitory storage medium according to claim 22, wherein
said instructions for performing game processing include
instructions for providing a second object of which movement in said virtual space is controlled,
instructions for controlling movement of said second object in accordance with the operation input accepted at prescribed timing in said first viewpoint mode, and
instructions for controlling movement of said second object in accordance with the operation input accepted at prescribed timing and instructions for controlling movement thereof in accordance with the position data of said operation apparatus at timing different from said prescribed timing in said second viewpoint mode.

26. The non-transitory storage medium according to claim 21, wherein
in said virtual space, said first virtual camera is set at a position higher than positions of said first object and said second virtual camera.

27. The non-transitory storage medium according to claim 21, wherein
a case where the position data of said operation apparatus is in said first range refers to a case where an orientation of a display surface of said display portion is close to horizontal, and a case where it is in said second range refers to a case where an orientation of the display surface of said display portion is close to vertical.

28. A non-transitory storage medium encoded with a computer readable program for controlling an information processing unit and executable by a computer of the information processing unit, said information processing unit operating in cooperation with an operation apparatus having a display portion for displaying information, said program comprising:
instructions for accepting a user's operation input;
instructions for obtaining first position data of an axis of a prescribed direction in a reference direction in a space where said operation apparatus is present and second position data around an axis of a second prescribed direction; and
instructions for performing game processing in accordance with the accepted operation input when the obtained first position data of said operation apparatus is in a first range and performing game processing in accordance with the accepted operation input and the obtained second position data of said operation apparatus when the obtained first position data of said operation apparatus is in a second range.
